(19) United States
(12) Patent Application Publication
(10) Pub. No.: US 2010/0309394 A1
(43) Pub. Date: Dec. 9, 2010

(54) DISPLAY DEVICE AND DRIVE METHOD FOR THE SAME

(75) Inventors: Takaji Numao, Osaka (JP); Osamu Teranuma, Osaka (JP)

Correspondence Address: HARNESS, DICKEY & PIERCE, P.L.C., P.O. BOX 8910, RESTON, VA, 20195, US

(73) Assignee: Sharp Kabushiki Kaisha, Osaka-shi, Osaka (JP)

(21) Appl. No.: 12/735,726

(22) PCT Filed: Oct. 27, 2008
(86) PCT No.: PCT/JP2008/069427

§ 371 Date: Aug. 12, 2010

(30) Foreign Application Priority Data
Mar. 18, 2008 (JP) 2008-068910

(51) Int. Cl. H04N 3/14

(52) U.S. Cl. 348/792; 348/E03.016

(57) ABSTRACT

At least one embodiment of the present invention aims to provide a display device capable of compensating for a change of a liquid crystal capacitance value for an electro-optic element such as a liquid crystal in accordance with a change of an application voltage to the electro-optic element, without incorporating frame memory. It also aims to improve the response speed of a display device without frame memory. For each pixel formation portion, a frame period is divided into first and second periods. During a frame period in which a target voltage having one of the positive and negative polarities with respect to a potential (Com) of an opposing electrode is to be applied to a pixel electrode, during the first period, a TFT is brought into conductive state and a voltage corresponding to the target voltage is applied to a source line (Sj), thereby providing the pixel electrode with a voltage of the other polarity with respect to the potential (Com) of the opposing electrode, while during the second period, the TFT is brought into non-conductive state and the voltage on an auxiliary capacitance line (Ck) is caused to change from the other polarity to one polarity with respect to the potential of the opposing electrode.

### TECHNICAL FIELD

The present invention relates to display devices such as liquid crystal display devices and drive methods for the same.

### BACKGROUND ART

In recent years, liquid crystal display devices for notebook computers, cell phones, liquid crystal televisions, etc., which use TFTs (Thin Film Transistors), have come into wide use. In a liquid crystal display device using TFTs, to control the state of display by a liquid crystal, a driver circuit called a “source driver” supplies voltage to the liquid crystal. For example, Japanese Laid-Open Patent Publication No. 2002-351409 discloses an invention of a liquid crystal display device having a configuration shown in FIG. 18. This liquid crystal display device is provided with a source driver 907 consisting of a plurality of source driver ICs 908, which supplies voltage to a liquid crystal.

FIG. 8 is a circuit diagram illustrating the configuration of a pixel formation portion in a typical liquid crystal display device. As shown in FIG. 8, each pixel formation portion includes a TFT 20 having a gate electrode 25 connected to a gate line Gi passing through a corresponding intersection and a source electrode 26 connected to a source line Sj passing through the intersection; a pixel electrode 21 connected to a drain electrode 27 of the TFT 20; an opposing electrode 24 commonly provided for a plurality of pixel formation portions in a display portion; an auxiliary capacitance line (auxiliary capacitance electrode) Ck provided corresponding to the gate line Gi; a liquid crystal capacitance 22 formed by the pixel electrode 21 and the opposing electrode 24; and an auxiliary capacitance 23 formed by the pixel electrode 21 and the auxiliary capacitance line Ck. Also, the liquid crystal capacitance 22 and the auxiliary capacitance 23 form a pixel capacitance. Furthermore, a voltage indicating a pixel value is retained in the pixel capacitance based on a video signal received by the source electrode 26 of the TFT 20 through the source line Sj when the gate electrode 25 of the TFT 20 receives an active scanning signal (selection signal) through the gate line Gi. Note that in the following descriptions, for capacitances such as liquid crystal capacitances and auxiliary capacitances, the term “capacitance (liquid crystal capacitance, auxiliary capacitance, etc.)” is used to refer to such capacitances themselves, and the term “capacitance value (liquid crystal capacitance value, auxiliary capacitance value, etc.)” is used to refer to their magnitudes.

Incidentally, the liquid crystal has such characteristics that “capacitance values (liquid crystal capacitance values) increase with increasing applied voltage (liquid crystal application voltage)”. The relationship between the liquid crystal application voltage and the liquid crystal capacitance value can be expressed by, for example, the “capacitance-voltage correspondence curve” of FIG. 19. Note that the relationship between the liquid crystal application voltage and the luminance (appearing on the display portion) for the normally black mode is as shown in the “luminance-voltage correspondence curve” of FIG. 19. (In the case of the normally white mode, conversely, the luminance decreases as the application voltage increases.)

Referring now to FIGS. 8 and 19, an operation will be described where the liquid crystal application voltage is caused to change from Vα to Vβ. First, the liquid crystal application voltage changes to Vβ, thereby charge Q expressed by “(Cα+Cs)×Vβ” is accumulated in the pixel electrode 21. Note that Cα is a liquid crystal capacitance value where the liquid crystal application voltage is Vα, and Cs is an auxiliary capacitance value.

Next, in accordance with the rise of the liquid crystal application voltage from Vα to Vβ, the liquid crystal capacitance value rises from Cα to Cγ by the next frame period (after the frame period in which Vβ was applied to the liquid crystal), as shown in the “capacitance-voltage correspondence curve” of FIG. 19. At this time, the TFT 20 is in non-conductive state, so that charge Q accumulated in the pixel electrode 21 is retained. As a result, the liquid crystal application voltage falls from Vβ to Vγ. In this manner, even when a voltage corresponding to a target luminance is applied to the liquid crystal during a certain frame period, the liquid crystal application voltage falls by the next frame period. Accordingly, some frame periods are spent before the target luminance is reached. As a result, when a display is provided such that images change every frame, satisfactory display quality is not obtained.

Therefore, in the aforementioned liquid crystal display device described in Japanese Laid-Open Patent Publication No. 2002-351409, a voltage above the voltage corresponding to a target luminance is applied to the liquid crystal, thereby compensation for “a change of the liquid crystal capacitance value in accordance with a change of the liquid crystal application voltage” is performed. Note that such a drive method is referred to as, for example, “overdrive (driving)” or “overshoot (driving)”. The liquid crystal display device described in Japanese Laid-Open Patent Publication No. 2002-351409 has an overdrive controller 910 provided between an LCD controller 904 and a source driver 907, as shown in FIG. 18.

FIG. 20 is a block diagram illustrating the configuration of the overdrive controller 910. The overdrive controller 910 is composed of an overdrive voltage calculation portion 911, a capacitance estimation portion 912, and a frame buffer 913. The capacitance estimation portion 912 estimates a capacitance value (liquid crystal capacitance value) for the next frame. The frame buffer 913 stores the capacitance value estimated by the capacitance estimation portion 912. The overdrive voltage calculation portion 911 calculates a voltage (overdrive voltage) to be applied to the liquid crystal based on a target luminance sent by the LCD controller 904 and a capacitance value stored into the frame buffer 913 during the previous frame.

With such a configuration, when the liquid crystal application voltage for the target luminance is Vβ, the liquid crystal application voltage is caused to change from Vα to Vε, a voltage having a value calculated by equation (1) below.

$$\begin{matrix}[ Eq . 1 ] & \\ V ɛ = \frac{C β \times V β}{C α} & ( 1 )\end{matrix}$$

Here, Cβ denotes a liquid crystal capacitance value where the liquid crystal application voltage is Vβ.

In accordance with the rise of the liquid crystal application voltage from Vα to Vε as described above, the liquid crystal capacitance value rises from Cα to Cβ by the next frame period (after the frame period in which Vε was applied to the liquid crystal), as shown in the “capacitance-voltage correspondence curve” of FIG. 19. At this time, the charge accumulated in the pixel electrode is retained as described above, and therefore the liquid crystal application voltage falls from Vε to Vβ. In this manner, voltage Vβ corresponding to the target luminance is applied to the liquid crystal. Note that the state in which the liquid crystal capacitance value is unchanging (the state in which the liquid crystal capacitance value is kept constant and continuously stable) is referred to below as the “steady state”. Also, the state in which the liquid crystal capacitance value keeps changing in accordance with a change of the liquid crystal application voltage is referred to as the “transition state”, and a period in which the transition state appears (a period from the change of the liquid crystal application voltage up to the steady state) is referred to as a “transition period”.

In the liquid crystal display device configured as described above, to further shorten the liquid crystal response time, the liquid crystal application voltage can be voltage Vd having such a value as to establish equation (2) below.

$$\begin{matrix}[ Eq . 2 ] & \\ Vd ≧ \frac{C β \times V β}{C α} & ( 2 )\end{matrix}$$

Also, Japanese Laid-Open Patent Publication No. 2007-122082 discloses a method in which the voltage on the auxiliary capacitance line is caused to change after the TFT of the pixel formation portion is brought into non-conductive state in the liquid crystal display device, thereby shifting the liquid crystal application voltage. FIGS. 21A to 21C are diagrams describing the operation of the pixel formation portion of the liquid crystal display device. In this liquid crystal display device, as shown in FIG. 21A, a TFT 116 is initially brought into conductive state so that voltage Vp is provided to a pixel electrode 118 through a source line 114. Then, as shown in FIG. 21B, the TFT 116 is brought into non-conductive state (OFF state) so that the voltage on an auxiliary capacitance line 113 is caused to change by Vq. At this time, assuming that the capacitance value of an auxiliary capacitance 119 connected to the pixel electrode 118 is Cstg and the capacitance value of a liquid crystal capacitance 105 is Clc, voltage Vr at the pixel electrode 118 is expressed by equation (3) below, as shown in FIG. 21C.

$$\begin{matrix}[ Eq . 3 ] & \\ Vr = Vp + \frac{Vq \times Cstg}{Cstg + Clc} & ( 3 )\end{matrix}$$

As a result, the voltage applied to the pixel electrode 118 becomes higher than voltage Vp provided to the source line by Vq×(Cstg/(Cstg+Clc)). In this manner, the voltage provided to the source line (hereinafter, referred to as the “source voltage”) can be set lower than the voltage to be applied to the pixel electrode, and therefore the amplitude of an output voltage from the source driver can be relatively small, as shown in FIGS. 22A and 22B.

[Patent Document 1] Japanese Laid-Open Patent Publication No. 2002-351409

[Patent Document 2] Japanese Laid-Open Patent Publication No. 2007-122082

### DISCLOSURE OF THE INVENTION

### Problems to be Solved by the Invention

However, in the case where the “configuration in which the overdrive voltage is applied to the liquid crystal”, as disclosed in Japanese Laid-Open Patent Publication No. 2002-351409, is employed, frame memory (frame buffer 913 of FIG. 20) is required. Therefore, cost increase is problematic, particularly with medium- or small-sized liquid crystal display devices called “mobile devices”.

Also, in the liquid crystal display device described in Japanese Laid-Open Patent Publication No. 2007-122082, although a frame memory is not needed, the change of the liquid crystal capacitance value in accordance with the change of the liquid crystal application voltage is not compensated. This will be described below with reference to FIGS. 21 and 23.

First, as shown in FIG. 23A, the TFT 116 is brought into conductive state so that charge Qs expressed by equation (4) below is accumulated in the pixel electrode 118.

[Eq. 4]

Qs=Cα(Vp−Vc)+Cstg(Vp−Vst(−)) (4)

Here, Cα denotes a liquid crystal capacitance value immediately before the TFT 116 changes from conductive state to non-conductive state, Vp denotes a voltage provided to the pixel electrode 118 through the source line 112, Vc denotes a voltage provided to an opposing electrode (common electrode) Lcom, Cstg denotes an auxiliary capacitance value, and Vst(−) denotes a voltage provided to the auxiliary capacitance line 113.

Next, as shown in FIG. 23B, the TFT 116 is brought into non-conductive state so that the voltage provided to the auxiliary capacitance line 113 changes from Vst(−) to Vst(+). At this time, according to the charge conservation law, an equation indicated below is established between the state shown in FIG. 23A (hereinafter, referred to as the “pre-change state”) and the state shown in FIG. 23B (hereinafter, referred to as the “post-change state”).

$$\begin{matrix} [ Eq . 5 ] & \\ C α ( Vp - Vc ) + Ctsg ( Vp - Vst ( - ) ) = C x ( Vx - Vc ) + Cstg ( Vx - Vst ( + ) ) & ( 5 ) \\ ∴ ( C x + Cstg ) Vx = ( C α + Ctsg ) Vp + ( Cx - C α ) Vc + 2 Cstg \times Vst ( + ) & \\ ∴ Vx = \frac{( C α + Cstg ) Vp + ( Cx - C α ) Vc + 2 Ctsg \times Vst ( + )}{Cx + Cstg} & \end{matrix}$$

Here, Vx denotes a voltage provided to the pixel electrode 118 in the post-change state, and Cx denotes a liquid crystal capacitance value when aforementioned voltage Vx is provided to the pixel electrode 118.

From equation (5), the liquid crystal application voltage “Vx−Vc” in the post-change state is expressed by equation (6) below.

$$\begin{matrix}[ Eq . 6 ] & \\ \begin{matrix}V x - V c = \frac{\begin{matrix}( C α + Cstg ) V p + ( C x - C α ) V c - \\ ( C x + Cstg ) V c + 2 Cstg \times Vst ( + )\end{matrix}}{C x + Ctsg} \\ = \frac{( C α + Cstg ) V p - ( C α + Cstg ) V c + 2 Cstg \times Vst ( + )}{C x + Cstg} \\ = \frac{( C α + Cstg ) ( V p - V c ) + 2 Cstg \times Vst ( + )}{C x + Cstg}\end{matrix} & ( 6 )\end{matrix}$$

Note that Vp in equation (6) is set such that the absolute value of the liquid crystal application voltage equals “Vβ” when a voltage having an absolute value of “Vp” is continuously applied to the pixel electrode 118.

Incidentally, voltage Vp provided to the pixel electrode 118 in the pre-change state and voltage Vst (+) provided to the auxiliary capacitance line 113 in the post-change state are equalized in polarity. As a result, in equation (6), “Vx−Vc” decreases as Cx increases. Accordingly, “Vx−Vc” decreases as the liquid crystal capacitance value increases from Cα to Cx. As described above, in the liquid crystal display device described in Japanese Laid-Open Patent Publication No. 2007-122082, the change of the liquid crystal capacitance value in accordance with the change of the liquid crystal application voltage is not compensated.

Therefore, an objective of the present invention is to provide a display device capable of improving the response speed without incorporating frame memory.

### Means for Solving the Problems

A first aspect of the present invention is directed to a display device comprising:

a plurality of video signal lines;

a plurality of scanning signal lines crossing the video signal lines;

a plurality of auxiliary capacitance lines provided in one-to-one correspondence with the scanning signal lines;

a plurality of pixel formation portions arranged in a matrix at their respective intersections of the video signal lines and the scanning signal lines, the pixel formation portions each including an element capacitance for accumulating a charge corresponding to a luminance of an image to be displayed and an auxiliary capacitance provided in parallel with the element capacitance; and

a driver circuit for controlling voltages to be applied to the video signal lines, the scanning signal lines, and the auxiliary capacitance lines, thereby controlling voltages to be applied to the element capacitances and the auxiliary capacitances, wherein,

each pixel formation portion includes a switching element controlled in terms of conductive/non-conductive state by a scanning signal provided through a corresponding scanning signal line, a pixel electrode electrically connected to a corresponding video signal line via the switching element, a common electrode for forming the element capacitance between the pixel electrode and the common electrode, and the auxiliary capacitance line for forming the auxiliary capacitance between the pixel electrode and the auxiliary capacitance line,

for any given pixel formation portion, a frame period which is a period in which a display for one screen is provided consists of a first period and a second period which is a period other than the first period, and

for each pixel formation portion, during the frame period in which a target voltage is to be applied to the pixel electrode, the target voltage corresponding to the luminance of the image to be displayed and having one of the positive and negative polarities with respect to a potential of the common electrode, during the first period, the driver circuit brings the switching element into conductive state by applying a predetermined selection voltage to the corresponding scanning signal line and applies a voltage to the corresponding video signal line based on the target voltage, thereby applying to the pixel electrode a voltage of the other polarity with respect to the potential of the common electrode, while during the second period, the driver circuit brings the switching element into non-conductive state by applying a predetermined non-selection voltage to the corresponding scanning signal line and changes a voltage applied to a corresponding auxiliary capacitance line from the other polarity to one polarity with respect to the potential of the common electrode.

In a second aspect of the present invention, based on the first aspect of the invention, the driver circuit further applies a voltage to the common electrode, the voltage alternating between the positive and negative polarities with respect to a predetermined potential every predetermined period, and

for each pixel formation portion, upon transition from the first period to the second period, the driver circuit changes the voltage applied to the common electrode from one polarity to the other polarity with respect to the predetermined potential.

In a third aspect of the present invention, based on the second aspect of the invention, for each pixel formation portion, after the driver circuit changes the voltage applied to the common electrode upon transition from the first period to the second period, during the second period, the driver circuit lowers the potential of the corresponding auxiliary capacitance line when the voltage applied to the common electrode is caused to change from the positive polarity to the negative polarity, and raises the potential of the corresponding auxiliary capacitance line when the voltage applied to the common electrode is caused to change from the negative polarity to the positive polarity.

In a fourth aspect of the present invention, based on the second aspect of the invention, for each pixel formation portion, after the driver circuit changes the voltage applied to the common electrode upon transition from the first period to the second period, the driver circuit brings the corresponding auxiliary capacitance line into an electrically floating state during the second period.

In a fifth aspect of the present invention, based on the first aspect of the invention, the driver circuit drives the auxiliary capacitance lines independently of one another.

In a sixth aspect of the present invention, based on the first aspect of the invention, the auxiliary capacitance lines are divided into a plurality of groups by short-circuiting a plurality of lines with each other, and

the driver circuit drives the auxiliary capacitance lines group by group.

A seventh aspect of the present invention is directed to a drive method for a display device, wherein,

the display device includes:
a plurality of video signal lines;
a plurality of scanning signal lines crossing the video signal lines;
a plurality of auxiliary capacitance lines provided in one-to-one correspondence with the scanning signal lines; and
a plurality of pixel formation portions arranged in a matrix at their respective intersections of the video signal lines and the scanning signal lines, the pixel formation portions each including an element capacitance for accumulating a charge corresponding to a luminance of an image to be displayed and an auxiliary capacitance provided in parallel with the element capacitance,

each pixel formation portion includes a switching element controlled in terms of conductive/non-conductive state by a scanning signal provided through a corresponding scanning signal line, a pixel electrode electrically connected to a corresponding video signal line via the switching element, a common electrode for forming the element capacitance between the pixel electrode and the common electrode, and the auxiliary capacitance line for forming the auxiliary capacitance between the pixel electrode and the auxiliary capacitance line,

for any given pixel formation portion, a frame period which is a period in which a display for one screen is provided consists of a first period and a second period which is a period other than the first period, and

the method comprises first and second drive steps for each pixel formation portion:
the first drive step being such that, during the frame period in which a target voltage is to be applied to the pixel electrode, the target voltage corresponding to the luminance of the image to be displayed and having one of the positive and negative polarities with respect to a potential of the common electrode, during the first period, the switching element is brought into conductive state by applying a predetermined selection voltage to the corresponding scanning signal line and a voltage is applied to the corresponding video signal line based on the target voltage, thereby applying to the pixel electrode a voltage of the other polarity with respect to the potential of the common electrode; and
the second drive step being such that, during the frame period in which the target voltage is to be applied to the pixel electrode, during the second period, the switching element is brought into non-conductive state by applying a predetermined non-selection voltage to the corresponding scanning signal line and a voltage applied to a corresponding auxiliary capacitance line is changed from the other polarity to one polarity with respect to the potential of the common electrode.

In an eighth aspect of the present invention, based on the seventh aspect of the invention, the method further comprising a common electrode drive step of applying a voltage to the common electrode, the voltage alternating between the positive and negative polarities with respect to a predetermined potential every predetermined period, wherein,

in the common electrode drive step, for each pixel formation portion, upon transition from the first period to the second period, the voltage applied to the common electrode is caused to change from one polarity to the other polarity.

In a ninth aspect of the present invention, based on the eighth aspect of the invention, in the second drive step, for each pixel formation portion, after changing the voltage applied to the common electrode upon transition from the first period to the second period, during the second period, the potential of the corresponding auxiliary capacitance line is lowered when the voltage applied to the common electrode changes from the positive polarity to the negative polarity, and the potential of the corresponding auxiliary capacitance line is raised when the voltage applied to the common electrode changes from the negative polarity to the positive polarity.

In a tenth aspect of the present invention, based on the eighth aspect of the invention, in the second drive step, for each pixel formation portion, after changing the voltage applied to the common electrode upon transition from the first period to the second period, the corresponding auxiliary capacitance line is brought into an electrically floating state during the second period.

In an eleventh aspect of the present invention, based on the seventh aspect of the invention, in the first and second drive steps, the auxiliary capacitance lines are driven independently of one another.

In a twelfth aspect of the present invention, based on the seventh aspect of the invention, the auxiliary capacitance lines are divided into a plurality of groups by short-circuiting a plurality of lines with each other, and

in the first and second drive steps, the auxiliary capacitance lines are driven group by group.

### EFFECTS OF THE INVENTION

The following effects can be achieved by the first aspect of the present invention. Note that it is assumed here that a target voltage to be applied to the element capacitance is Vβ, a voltage applied to the pixel electrode during the first period is Vμ, a voltage applied to the auxiliary capacitance line during the first period is Va, a voltage applied to the auxiliary capacitance line during the second period is Vb, an element capacitance value during the first period is Cα, and an element capacitance value corresponding to the target voltage Vβ is Cβ. In a frame period in which the target voltage Vβ of one polarity is to be applied to the element capacitance, during the first period, the voltage Vβ of the other polarity based on the target voltage Vβ is applied to the pixel electrode, and during the second period, the voltage on the auxiliary capacitance line changes from the voltage Va of the other polarity to the voltage Vb of one polarity. Here, the voltage Vμ can be set such that the voltage applied to the element capacitance is Vβ during the second period when the element capacitance value is in steady state at Cβ through the first and second periods. By setting the voltage Vμ in such a manner, a charge Cα×Vμ provided to the element capacitance during the first period becomes lower than Cβ×Vβ (in absolute value) when the element capacitance value Cα during the first period is lower than Cβ. The voltage Vμ is opposite in polarity to the target voltage Vβ, and therefore the voltage applied to the element capacitance during the second period becomes higher than the target voltage Vβ as the charge provided to the element capacitance during the first period decreases. Accordingly, when a transition state is such that the element capacitance value changes from low value to high value, a voltage above the target voltage Vβ is applied to the element capacitance. On the other hand, when the element capacitance value Cα during the first period is higher than Cβ, the charge Cα×Vμ provided to the element capacitance during the first period becomes higher than Cβ×Vβ (in absolute value). The voltage Vμ is opposite in polarity to the target voltage Vβ, and therefore the voltage applied to the element capacitance during the second period becomes lower than the target voltage Vβ as the charge provided to the element capacitance during the first period increases. Accordingly, when the transition state is such that the element capacitance value changes from high value to low value, a voltage below the target voltage Vβ is applied to the element capacitance.

According to the second aspect of the present invention, positive-polarity voltage and negative-polarity voltage are alternatingly applied to the common electrode. As a result, the amplitude of a video signal can be reduced when compared to a configuration in which a constant voltage is applied to the common electrode.

According to the third aspect of the present invention, during the second period, the potential of the auxiliary capacitance line changes in accordance with the change of the potential of the common electrode. As a result, the amount of charge redistributed between the auxiliary capacitance and the element capacitance decreases, and therefore a stable voltage is applied to the element capacitance.

According to the fourth aspect of the present invention, the auxiliary capacitance line is brought into an electrically floating state during the second period. Here, the pixel electrode and the common electrode are capacitively coupled, and the pixel electrode and the auxiliary capacitance line are capacitively coupled. Accordingly, during the second period, the potential of the auxiliary capacitance line changes in accordance with the change of the potential of the common electrode. As a result, a stable voltage is applied to the element capacitance, as in the third aspect of the present invention.

According to the fifth aspect of the present invention, it is ensured that the second period is ensured to be long enough to apply the target voltage to the element capacitance.

According to the sixth aspect of the present invention, for the auxiliary capacitance lines, a plurality of them are driven at a time, and therefore the scale of the circuit for driving the auxiliary capacitance lines can be reduced.

### BRIEF DESCRIPTION OF THE DRAWINGS

FIGS. 1A to 1H are signal waveform diagrams describing a drive method for a liquid crystal display device according to a first embodiment of the present embodiment.

FIGS. 2A and 2B are diagrams describing a drive method according to the present invention.

FIG. 3 is a graph describing comparison results between the drive method according to the present invention and a drive method in the conventional art, regarding optical characteristics of the liquid crystal where the gray-scale value changes from 0 to 128.

FIG. 4 is a graph describing comparison results between the drive method according to the present invention and the drive method in the conventional art, regarding optical characteristics of the liquid crystal where the gray-scale value changes from 0 to 64.

FIG. 5 is a graph describing comparison results between the drive method according to the present invention and the drive method in the conventional art, regarding optical characteristics of the liquid crystal where the gray-scale value changes from 0 to 32.

FIG. 6 is a block diagram illustrating the overall configuration of the liquid crystal display device in the first embodiment.

FIG. 7 is a block diagram illustrating detailed configurations of drivers and a display portion in the first embodiment.

FIG. 8 is a circuit diagram illustrating the configuration of the pixel formation portions in the first embodiment and in the conventional art.

FIGS. 9A to 9C are charts describing the effect of the first embodiment.

FIG. 10 is a block diagram illustrating detailed configurations of drivers and a display portion in a liquid crystal display device according to a second embodiment of the present invention.

FIGS. 11A to 11H are signal waveform diagrams describing a drive method in the second embodiment.

FIGS. 12A to 12H are signal waveform diagrams describing a drive method in a variant of the second embodiment.

FIGS. 13A to 13H are signal waveform diagrams describing a drive method in another variant of the second embodiment.

FIGS. 14A to 14H are signal waveform diagrams describing a drive method for a liquid crystal display device according to a third embodiment of the present embodiment.

FIG. 15 is a block diagram illustrating detailed configurations of drivers and a display portion in a liquid crystal display device according to a fourth embodiment of the present invention.

FIGS. 16A to 16H are signal waveform diagrams describing a drive method in the fourth embodiment.

FIGS. 17A to 17H are signal waveform diagrams describing the drive method in the fourth embodiment.

FIG. 18 is a block diagram illustrating the configuration of a conventional liquid crystal display device (a liquid crystal display device described in Japanese Laid-Open Patent Publication No. 2002-351409).

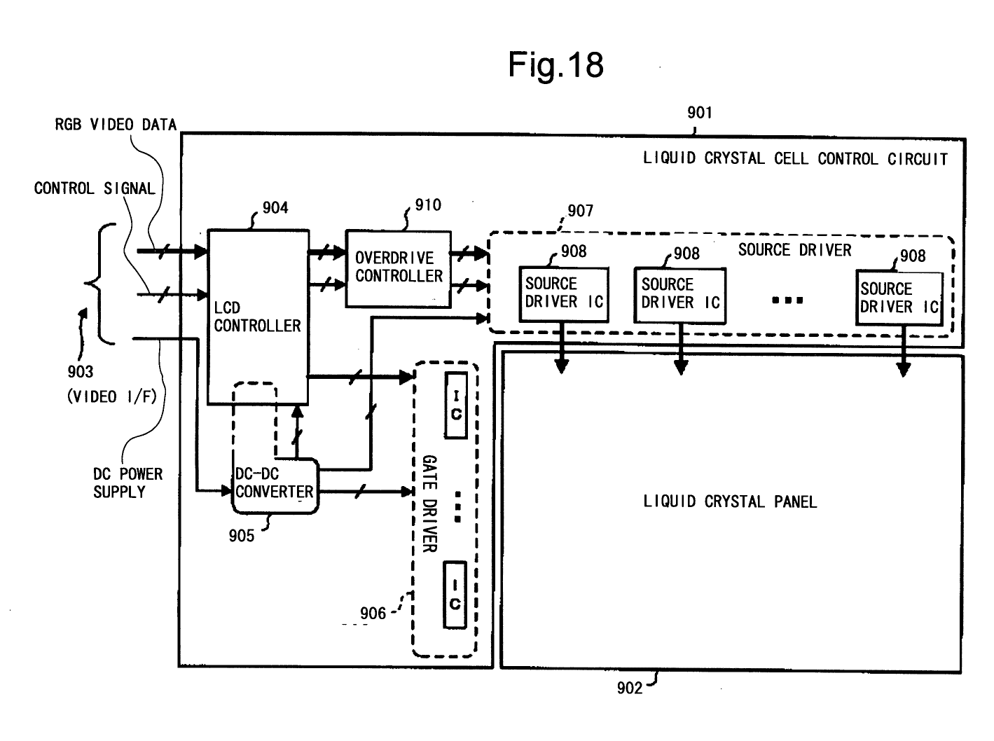

FIG. 19 is a graph illustrating the relationship between the liquid crystal application voltage and the liquid crystal capacitance value.

FIG. 20 is a block diagram illustrating the configuration of an overdrive controller in the conventional liquid crystal display device (the liquid crystal display device described in Japanese Laid-Open Patent Publication No. 2002-351409).

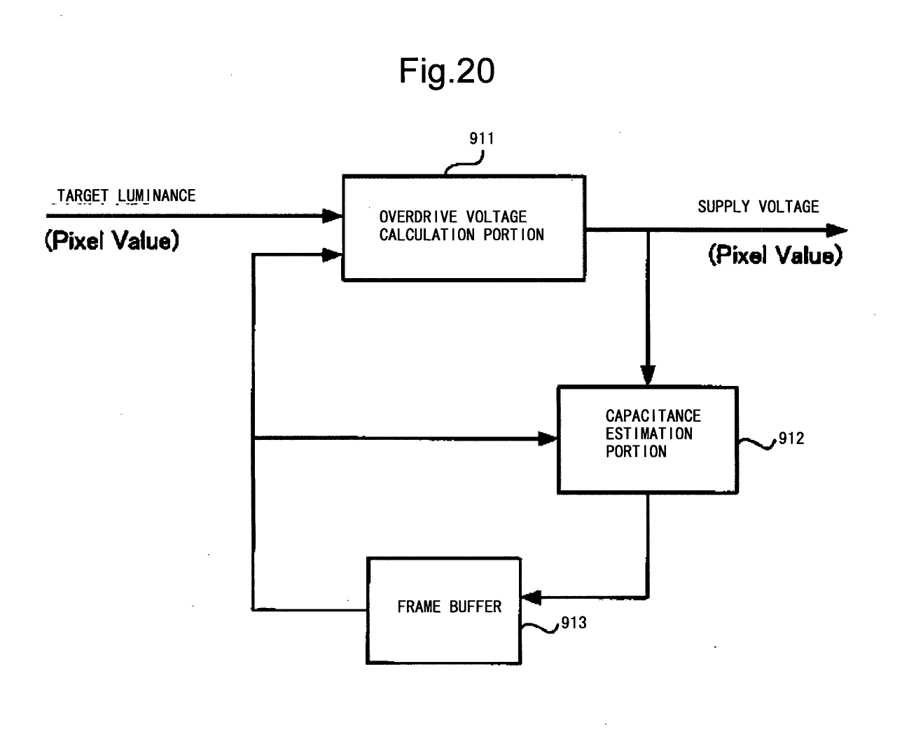

FIGS. 21A to 21C are diagrams describing a method for shifting a liquid crystal application voltage in a conventional liquid crystal display device (a liquid crystal display device described in Japanese Laid-Open Patent Publication No. 2007-122082).

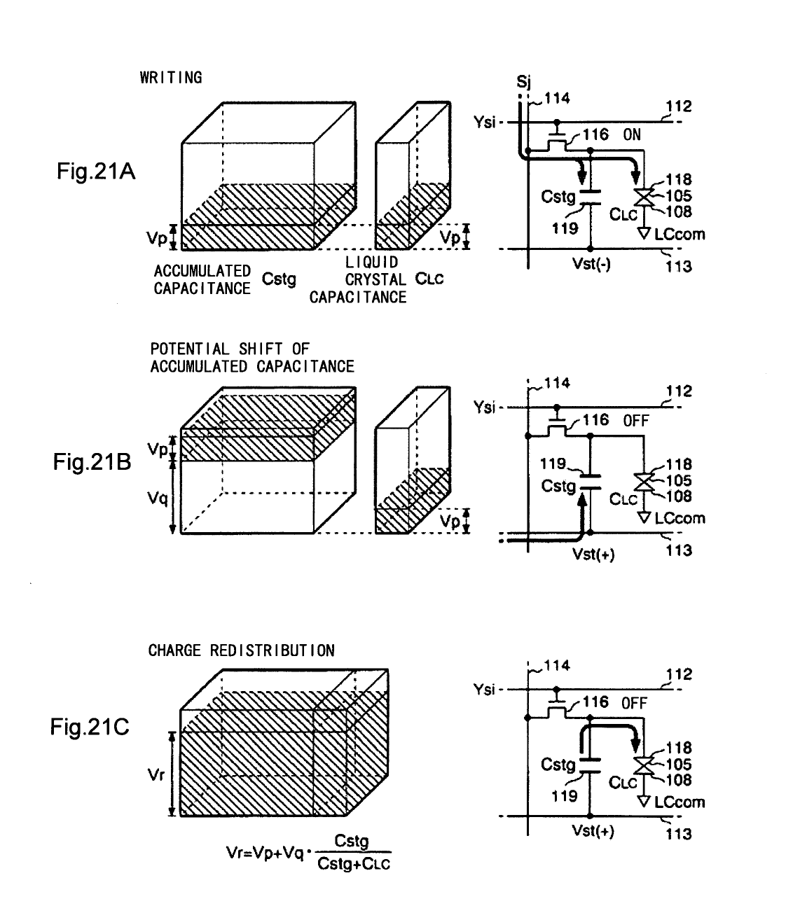

FIGS. 22A and 22B are signal waveform diagrams for the conventional liquid crystal display device (the liquid crystal display device described in Japanese Laid-Open Patent Publication No. 2007-122082).

FIGS. 23A and 23B are diagrams describing a drive method in the conventional art.

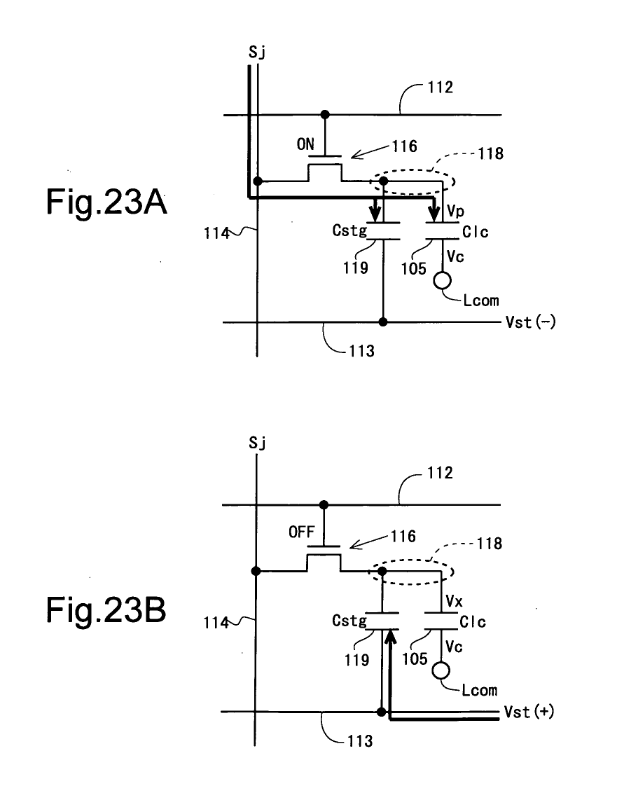

### DESCRIPTION OF THE REFERENCE NUMERALS

20 TFT
21 pixel electrode
22 liquid crystal capacitance
23 auxiliary capacitance
24 opposing electrode (common electrode)
100 display control circuit
200 display portion
300, 310 source driver
400 gate driver
500, 510 auxiliary capacitance driver
600 opposing electrode driver
Aij pixel formation portion
G1 to Gm gate line
S1 to Sn source line
C1 to Cm auxiliary capacitance line

### BEST MODE FOR CARRYING OUT THE INVENTION

### 1. Concept of the Present Invention

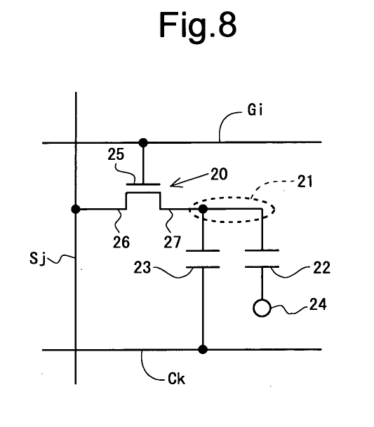

Before describing embodiments, the basic concept of the present invention will be described. Note that the description will be given here taking the following display device as an example. A display portion of the display device includes a plurality of source lines, a plurality of gate lines, and a plurality of pixel formation portions provided at their corresponding intersections of the source lines and the gate lines. The pixel formation portions form a pixel matrix of rows×columns. Also, the display portion is provided with a plurality of auxiliary capacitance lines corresponding to their respective gate lines. Furthermore, an opposing electrode is provided as a common electrode for the pixel formation portions. Each pixel formation portion is configured in the same manner as that shown in FIG. 8. Specifically, each pixel formation portion includes a TFT 20 as a switching element having a gate electrode 25 connected to a gate line Gi passing through a corresponding intersection and a source electrode 26 connected to a source line Sj passing through the intersection; a pixel electrode 21 connected to a drain electrode 27 of the TFT 20; a liquid crystal capacitance 22 as an element capacitance formed by the pixel electrode 21 and the opposing electrode 24; and an auxiliary capacitance 23 formed by the pixel electrode 21 and an auxiliary capacitance line Ck.

Note that in the present description, the term “voltage” is used to mean a “potential with respect to a predetermined potential (e.g., ground potential)”. For example, a “pixel electrode voltage” means the potential of a pixel electrode with respect to the predetermined potential. Also, one of the positive and negative polarities is referred to as “one polarity”, and an opposite polarity to the “one polarity” is referred to as the “other polarity”. That is, when “one polarity” means to the “positive polarity”, the “other polarity” means to the “negative polarity”, and when “one polarity” means the “negative polarity”, the “other polarity” means the “positive polarity”. Furthermore, voltages of different polarities are referred to by a “voltage of one polarity” and a “voltage of the other polarity”.

Next, a drive method in the display device according to the present invention will be described. Note that the description will be provided here focusing on one given pixel formation portion on the assumption that a voltage (hereinafter, referred to as a “target voltage”) Vβ of one polarity with respect to an opposing electrode voltage in that pixel formation portion is to be applied to the liquid crystal.

In this display device, a frame period, which is a period in which an image for one screen is displayed, conceptually includes first and second periods. The start and end points of the first and second periods differ among the rows that form the pixel matrix. Specifically, the first and second periods are equal in length for all rows, but the start and end points of each period vary from one row to another. For example, the start point of the first period in the second row is delayed by one horizontal scanning period from the start point of the first period in the first row. In this manner, the start point of the first period in the n'th row is delayed by (n−1) horizontal scanning periods from the start point of the first period in the first row. The same can be said of the end point of the first period and the start and end points of the second period.

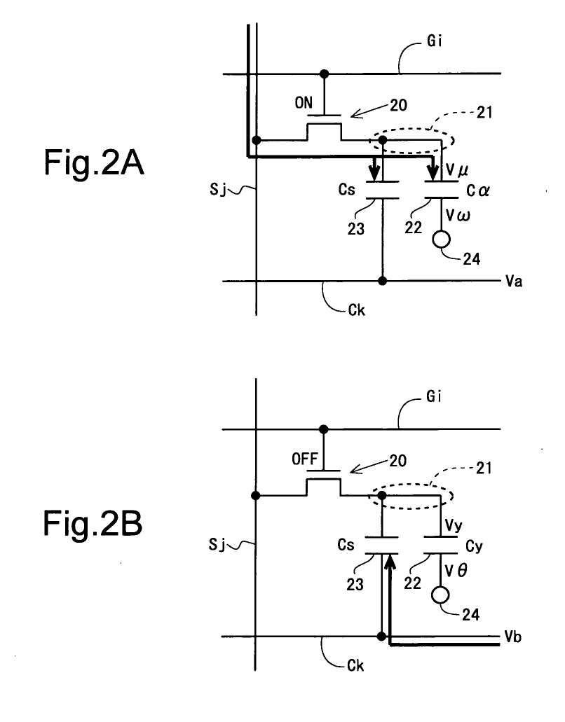

For each of the rows that form the pixel matrix, the display device is caused to operate as follows during each of the aforementioned first and second periods. During the first period, the TFT 20 is brought into conductive state so that a voltage of the other polarity with respect to the opposing electrode voltage is provided to the pixel electrode 21 through the source line Sj. During the second period, the TFT 20 is brought into non-conductive state and the polarity of the voltage on the auxiliary capacitance line Ck is caused to change to one polarity, so that a voltage of one polarity is provided to the pixel electrode 21. Referring to FIGS. 2A and 2B, a further detailed description will be provided below.

During the first period, as shown in FIG. 2A, the TFT 20 is brought into conductive state (ON state) so that a voltage (hereinafter, referred to as a “first-period pixel electrode voltage”) Vμ of the other polarity with respect to the opposing electrode voltage is provided to the pixel electrode 21 through the source line Sj. Also, during the first period, a voltage (hereinafter, referred to as a “first-period opposing electrode voltage”) Vω is provided to the opposing electrode 24, and a voltage (hereinafter, referred to as a “first-period auxiliary capacitance line voltage”) Va is provided to the auxiliary capacitance line Ck. Upon transition from the first period to the second period, as shown in FIG. 2B, the TFT 20 is brought into non-conductive state (OFF state), and the voltage on the auxiliary capacitance line Ck is caused to change to a voltage (hereinafter, referred to as “second-period auxiliary capacitance line voltage”) Vb of one polarity. Also, during the second period, a voltage (hereinafter, referred to as a “second-period opposing electrode voltage”) Vθ is provided to the opposing electrode 24.

When the display device is caused to operate as described above, the sum of a charge accumulated in the liquid crystal capacitance 22 and a charge accumulated in the auxiliary capacitance 23 is equalized between the first period (immediately before the start of the second period) and the second period in accordance with the charge conservation law. That is, an equation shown below is established.

$$\begin{matrix} [ Eq . 7 ] & \\ C α ( V μ - V ω ) + Cs ( V μ - Va ) = Cy ( Vy - V θ ) + Cs ( Vy - Vb ) & ( 7 ) \\ ∴ ( Cy + Cs ) Vy = ( C α + Cs ) V μ + ( CyV θ - C α V ω ) + Cs ( Vb - Va ) & \\ ∴ Vy = \frac{( C α + Cs ) V μ + ( CyV θ - C α V ω ) + Cs ( Vb - Va )}{Cy + Cs} & \end{matrix}$$

Here, Vy denotes a voltage (hereinafter, referred to as a “second-period pixel electrode voltage”) applied to the pixel electrode 21 at an arbitrary point in the second period, Cs denotes an auxiliary capacitance value, Cα denotes a liquid crystal capacitance value (hereinafter, referred to as a “first-period liquid crystal capacitance value”) in the first period (immediately before the start of the second period), and Cy denotes a liquid crystal capacitance value (hereinafter, referred to as a “second-period liquid crystal capacitance value”) at an arbitrary point in the second period.

From equation (7), a liquid crystal application voltage “Vy−Vθ” at an arbitrary point in the second period is expressed as follows.

$$\begin{matrix}[ Eq . 8 ] & \\ \begin{matrix}Vy - V θ = \frac{\begin{matrix}( C α + Cs ) V μ + ( CyV θ - C α V ω ) + \\ Cs ( Vb - Va ) - ( Cy + Cs ) V θ\end{matrix}}{Cy + Cs} \\ = \frac{( C α + Cs ) V μ - ( C α V ω + CsV θ ) + Cs ( Vb - Va )}{Cy + Cs} \\ = \frac{C α ( V μ - V ω ) + Cs ( V μ - V θ + Vb - Va )}{Cy + Cs}\end{matrix} & ( 8 )\end{matrix}$$

Note that the first-period pixel electrode voltage Vμ in equation (8) is set such that the liquid crystal application voltage takes an absolute value of “Vβ” when a voltage having an absolute value of “Vμ” is continuously applied to the pixel electrode 21. A specific setting method will be described later.

Also, when the gray-scale level is 255, the liquid crystal capacitance value is assumed to be C₂₅₅, and the liquid crystal application voltage is assumed to be V₂₅₅. Here, assuming that the normally black mode is employed, the first-period auxiliary capacitance line voltage Va and the second-period auxiliary capacitance line voltage Vb are set such that the liquid crystal application voltage is V₂₅₅ when the liquid crystal capacitance value is in steady state at C₂₅₅ through the first and second periods and the first-period pixel electrode voltage Vμ and the first-period opposing electrode voltage Vω are equal. Specifically, when “Cα=C₂₅₅” and “Cy=C₂₅₅” the first-period auxiliary capacitance line voltage Va, the second-period auxiliary capacitance line voltage Vb, the first-period opposing electrode voltage Vω, and the second-period opposing electrode voltage Vθ are set such that an equation below is established based on equation (8). (Note that in the case of the normally white mode, the first-period auxiliary capacitance line voltage Va and the second-period auxiliary capacitance line voltage Vb are set such that the liquid crystal application voltage is V₀ when the liquid crystal capacitance value is in steady state at C₀ through the first and second periods and the first-period pixel electrode voltage Vμ and the first-period opposing electrode voltage Vω are equal.)

$$\begin{matrix}[ Eq . 9 ] & \\ \begin{matrix}\begin{matrix}{V}_{255} = Vy - V θ \\ = \frac{C α ( V μ - V ω ) + Cs ( V μ - V θ + Vb - Va )}{Cy + Cs} \\ = \frac{Cs ( V ω - V θ + Vb - Va )}{{C}_{255} + Cs}\end{matrix} \\ ∴ ( {C}_{255} + Cs ) {V}_{255} = Cs ( V ω - V θ + Vb - Va ) \\ ∴ Vb - Va + V ω - V θ = \frac{( {C}_{255} + Cs ) {V}_{255}}{Cs}\end{matrix} & ( 9 )\end{matrix}$$

When the first-period auxiliary capacitance line voltage Va, the second-period auxiliary capacitance line voltage Vb, the first-period opposing electrode voltage Vω, and the second-period opposing electrode voltage Vθ are set such that equation (9) is established, equation (8) is transformed as follows through a period in which the liquid crystal application voltage changes from an arbitrary voltage Vα to a target voltage Vβ.

$$\begin{matrix}[ Eq . 10 ] & \\ \begin{matrix}Vy - V θ = \frac{C α ( V μ - V ω ) + Cs ( V μ - V θ + Vb - Va )}{Cy + Cs} \\ = \frac{C α ( V μ - V ω ) + Cs ( V μ + ( ( {C}_{255} + Cs ) {V}_{255} / Cs ) - V ω )}{C y + C s} \\ = \frac{C α ( V μ - V ω ) + Cs ( V μ - V ω ) + ( {C}_{255} + Cs ) {V}_{255}}{Cy + Cs} \\ = \frac{( C α + Cs ) ( V μ - V ω ) + ( {C}_{255} + Cs ) {V}_{255}}{Cy + Cs}\end{matrix} & ( 10 )\end{matrix}$$

Here, the first-period liquid crystal capacitance value Cα in equation (10) denotes a liquid crystal capacitance value in steady state with a voltage having an absolute value of “Vα” being continuously applied to the liquid crystal.

Furthermore, the first-period pixel electrode voltage Vμ is set such that “Vy−Vθ=Vβ” is established based on the following equation when the liquid crystal capacitance value is in steady state at Cβ through the first and second periods.

$$\begin{matrix}[ Eq . 11 ] & \\ \begin{matrix}\begin{matrix} V β = Vy - V θ \\ = \frac{( C β + Cs ) ( V μ - V ω ) + ( {C}_{255} + Cs ) {V}_{255}}{C β + Cs}\end{matrix} \\ ∴ ( C β + Cs ) V μ = ( C β + Cs ) V β + ( C β + Cs ) V ω - ( {C}_{255} + Cs ) {V}_{255} \\ ∴ V μ = V β + V ω - \frac{( {C}_{255} + Cs ) {V}_{255}}{C β + Cs}\end{matrix} & ( 11 )\end{matrix}$$

Also, when the liquid crystal capacitance value that is in steady state with a voltage having an absolute value of “Vβ” being continuously applied to the liquid crystal is assumed to be Cβ, the following equation is established based on equation (10) at an arbitrary point in a period (transition period) in which the liquid crystal application voltage changes from “Vα” to “Vβ”.

$$\begin{matrix}[ Eq . 12 ] & \\ \begin{matrix}Vy - V θ = \frac{( C α + Cs ) ( V μ - V ω ) + ( {C}_{255} + Cs ) {V}_{255}}{Cy + Cs} \\ = \frac{( C α + Cs ) ( V β - ( {C}_{255} + Cs ) {V}_{255} / ( C β + Cs ) ) + ( {C}_{255} + Cs ) {V}_{255}}{Cy + Cs} \\ = \frac{( C α + Cs ) V β + ( {C}_{255} + Cs ) {V}_{255} \times ( 1 - ( C α + Cs ) / ( C β + Cs ) )}{Cy + Cs} \\ = \frac{( C α + Cs ) ( C β + Cs ) V β + ( {C}_{255} + Cs ) {V}_{255} \times ( ( C β + Cs ) - ( C α + Cs ) )}{( Cy + Cs ) ( C β + Cs )} \\ = \frac{( C α + Cs ) ( C β + Cs ) V β + ( C β - Cα ) ( {C}_{255} + Cs ) {V}_{255} )}{( Cy + Cs ) ( C β + Cs )} \\ = \frac{( Cy + Cs ) ( C β + Cs ) V β + ( C α - Cy ) ( C β + Cs ) V β + ( C β - C α ) ( {C}_{255} + Cs ) {V}_{255} )}{( Cy + Cs ) ( C β + Cs )} \\ = V β + \frac{( C α - Cy ) ( C β + Cs ) V β + ( C β - C α ) ( {C}_{255} + Cs ) {V}_{255}}{( Cy + Cs ) ( C β + Cs )} \\ = V β + \frac{( C α + Cy ) ( C β + Cs ) V β + ( C β - C α ) ( C β + Cs ) {V}_{255} + ( C β - C α ) ( {C}_{255} - C β ) {V}_{255}}{( Cy + Cs ) ( C β + Cs )} \\ = V β + \frac{( C β + C α ) {V}_{255} - ( Cy - C α ) V β}{Cy + Cs} + \frac{( C β - C α ) ( {C}_{255} - C β ) {V}_{255}}{( Cy + Cs ) ( C β + Cs )}\end{matrix} & ( 12 )\end{matrix}$$

Here, focusing on the last row of the right-hand side of equation (12), when “Cy=Cα” and “Cy=Cβ”, i.e., when steady state is maintained through the first and second periods, the second and third terms are “0”. Accordingly, when steady state is maintained through the first and second periods, the liquid crystal application voltage “Vy−Vθ” is Vβ.

When “Cβ>Cy” and “Cy>Cα”, i.e., when the transition state is such that the liquid crystal capacitance value changes from low value to high value, the second and third terms in the last row of the right-hand side of equation (12) have positive values. The reason for this is that “V₂₅₅≧Vβ” and also “(Cβ−Cα)>(Cy−Cα)”. Accordingly, In the case of such a transition state, the liquid crystal application voltage “Vy−Vθ” is above the target voltage Vβ. In other words, during a period after transition from the first period to the second period but before steady state is achieved, a voltage above the target voltage Vβ is applied to the liquid crystal. As a result, the response speed of the liquid crystal is improved. Note that it is also conceivable that a state where “Cy>Cβ” and “Cβ>Cα” is temporarily achieved. However, in such a case, the liquid crystal capacitance value has already exceeded a target capacitance value. In the case of the normally black mode, such a state is a state (overshoot state) in which the transmittance of the liquid crystal exceeds a target transmittance, and therefore it is rather preferable that the second and subsequent terms in the last row of the right-hand side of equation (12) have negative values, reducing the liquid crystal application voltage.

When “Cβ<Cy” and “Cy<Cα”, i.e., when the transition state is such that the liquid crystal capacitance value changes from high value to low value, the second and third terms in the last row of the right-hand side of equation (12) have negative values. Accordingly, in such a transition state, the liquid crystal application voltage “Vy−Vθ” is below the target voltage Vβ. In other words, during a period after transition from the first period to the second period but before steady state is achieved, a voltage below the target voltage Vβ is applied to the liquid crystal. As a result, the response speed of the liquid crystal is improved.

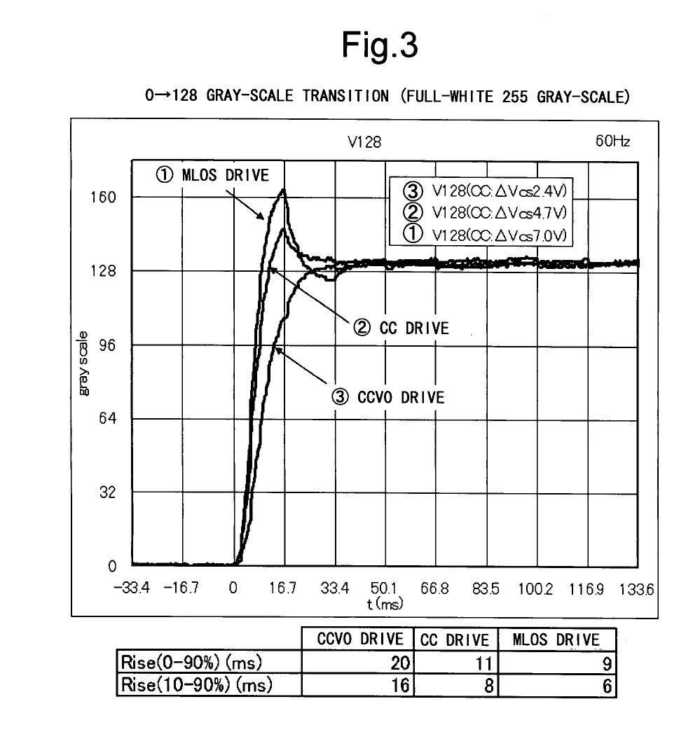

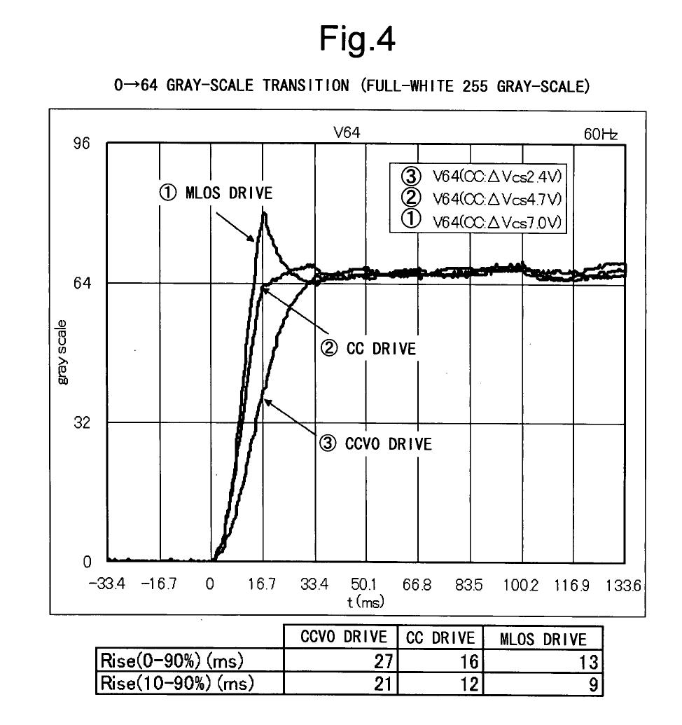

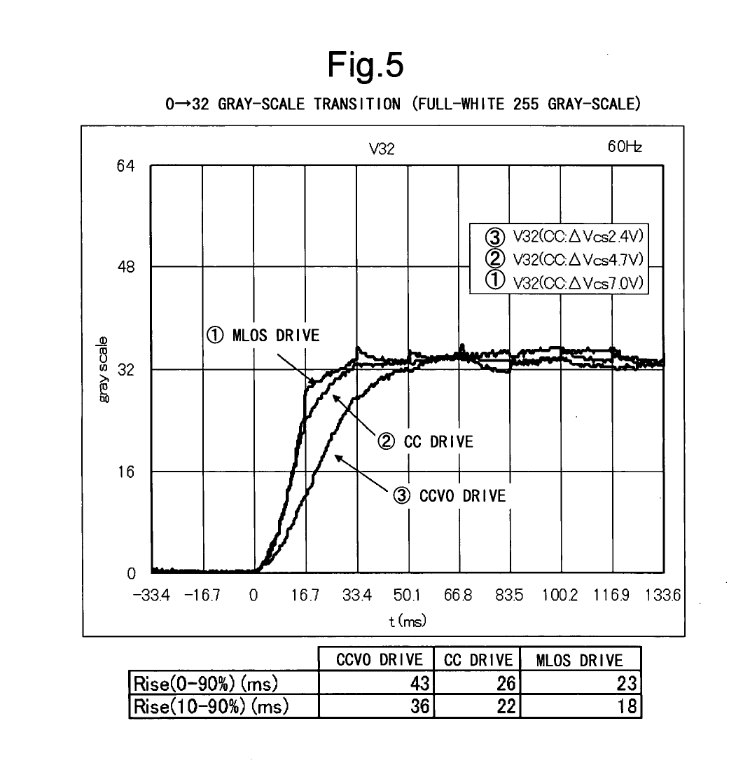

Described next are comparison results between optical characteristics of the liquid crystal that are obtained by the drive method according to the present invention and those obtained by the aforementioned drive method disclosed in Japanese Laid-Open Patent Publication No. 2007-122082. FIG. 3 is a graph showing optical characteristics of the liquid crystal for each drive method where the gray-scale value changes from 0 to 128. FIG. 4 is a graph showing optical characteristics of the liquid crystal for each drive method where the gray-scale value changes from 0 to 64. FIG. 5 is a graph showing optical characteristics of the liquid crystal for each drive method where the gray-scale value changes from 0 to 32. In any of FIGS. 3 to 5, the maximum gray-scale value is 255. Note that the drive method according to the present invention is referred to as “MLOS drive”, and the drive method disclosed in Japanese Laid-Open Patent Publication No. 2007-122082 is referred to as “CC drive” when the opposing electrode voltage is set as the mean value of the source line voltage, and the drive method disclosed in Japanese Laid-Open Patent Publication No. 2007-122082 is also referred to as “CCV0 drive” when the opposing electrode voltage is set at a 0 gray-scale voltage.

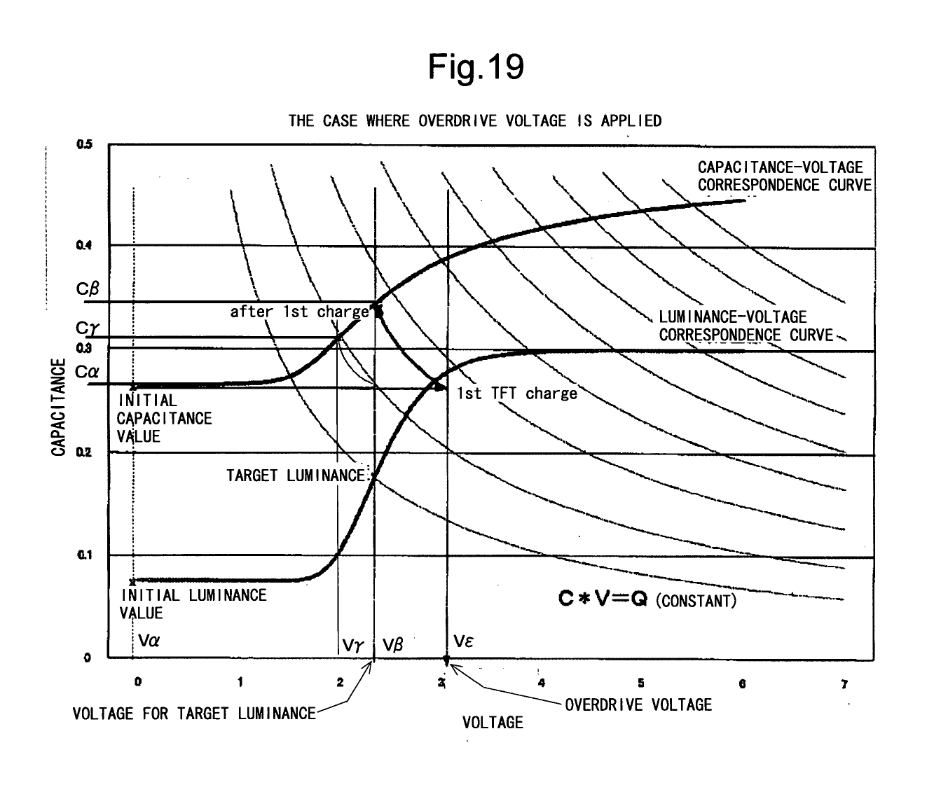

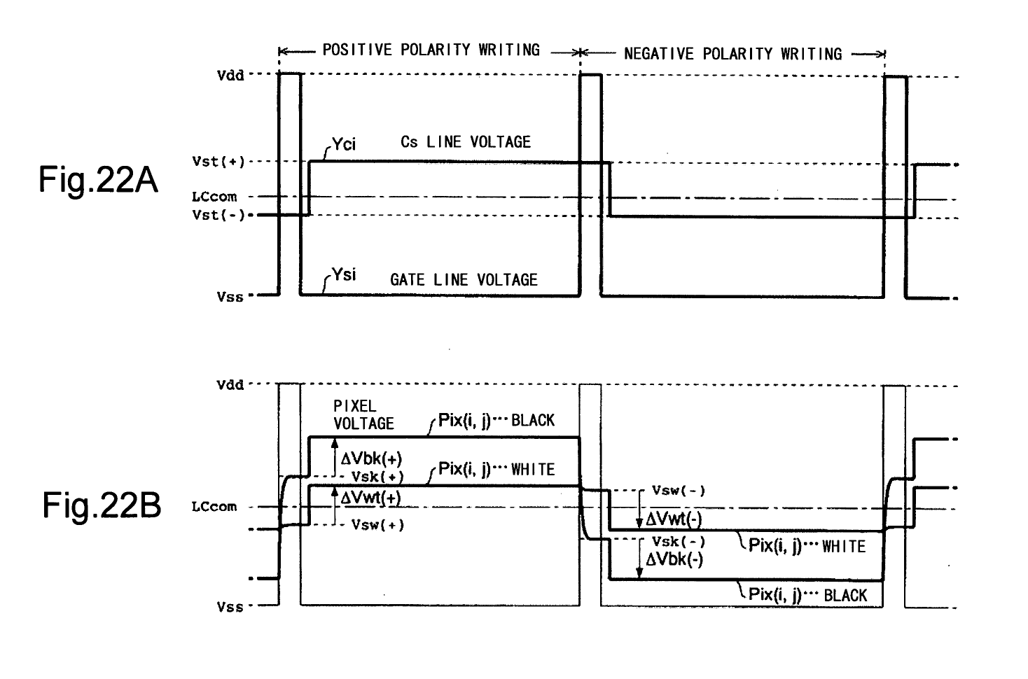

Focusing on optical characteristics for MLOS drive in FIG. 3, it is confirmed from the optical characteristics that a voltage having a value higher than a target voltage value is applied to the liquid crystal during the transition period (hereinafter, such an effect will be referred to as an “overshoot effect”). Note that the overshoot effect is also achieved by CC drive. A possible reason for this is that, under condition that the opposing electrode voltage LCcom shown in FIG. 22 is set as the mean value of the source line voltage, the opposing electrode voltage LCcom is a voltage for a gray-scale level of 128 or higher, as can be appreciated from the “luminance-voltage correspondence curve” shown in FIG. 19. Note that in the case of CCV0 drive, no overshoot effect is achieved.

Focusing on FIG. 4, while the overshoot effect is achieved for MLOS drive, no overshoot effect is confirmed for CC drive. For CCV0 drive, no overshoot effect is achieved. This seems to be because, for MLOS drive, an intense overshoot effect is obtained even during transition periods between relatively low gray-scale levels by setting the opposing electrode voltage on the 255 gray-scale side (between the 0 gray-scale side and the 255 gray-scale side for the source voltage).

Note that during transition periods between extremely low gray-scale levels, no overshoot effect is confirmed even for MLOS drive, as shown in FIG. 5. This is because any response in which a luminance corresponding to a gray-scale level above a target gray-scale level temporarily appears does not occur when the liquid crystal is driven at low speed. However, even in this case, it can be appreciated from FIG. 5 that the response speed is improved for MLOS drive when compared to CC drive and CCV0 drive.

As described above, in the display device according to the present invention, when the liquid crystal application voltage changes, if a target voltage is above a pre-change voltage (a voltage for the previous frame), a voltage above the target voltage is temporarily applied to the liquid crystal, and if the target voltage is below the pre-change voltage, a voltage below the target voltage is temporarily applied to the liquid crystal. As a result, the response speed of the liquid crystal is improved without incorporating frame memory.

Hereinafter, two configurations to embody the display device according to the present invention will be described.

### 1.1 First Configuration

First, a drive method for a first configuration will be described with reference to FIG. 8. During the first period, the TFT 20 is brought into conductive state so that a voltage of the other polarity with respect to the opposing electrode voltage is provided to the pixel electrode 21 through the source line Sj. During the second period, the TFT 20 is brought into non-conductive state so that the polarity of the voltage on the auxiliary capacitance line Ck changes from the other polarity to one polarity. The opposing electrode voltage is kept at a constant voltage value during the operation of the display device.

Note that in the first configuration, since a voltage value of the opposing electrode voltage is set to be constant as described above, the amplitude of the voltage that is to be provided to the source line Sj to realize alternating-current drive of the liquid crystal is increased. Therefore, a second configuration to be described later is preferable for the case where it is desirable that the amplitude of the voltage to be provided to the source line Sj be low.

### 1.2 Second Configuration

Next, a drive method for the second configuration will be described with reference to FIG. 8. During the first period, the TFT 20 is brought into conductive state so that a voltage of the other polarity with respect to the opposing electrode voltage is provided to the pixel electrode 21 through the source line Sj. During the second period, the TFT 20 is brought into non-conductive state so that the polarity of the opposing electrode voltage is caused to change to the other polarity and the polarity of the voltage on the auxiliary capacitance line Ck is caused to change from the other polarity to one polarity.

In the second configuration, as described above, the polarity of the opposing electrode voltage is caused to change. Here, when the application voltage to the liquid crystal is to be set at the positive polarity, the first-period opposing electrode voltage Vω is set at the positive polarity with respect to the center of the amplitude of the source voltage, so that the polarity of the source voltage becomes negative (during the first period) with respect to the first-period opposing electrode voltage Vω. After such a source voltage is provided to the pixel electrode 21 during the first period, during the second period, the opposing electrode voltage is caused to change to the negative polarity and also the voltage on the auxiliary capacitance line Ck is caused to change to the positive polarity. As a result, the voltage of the positive polarity is applied to the liquid crystal. On the other hand, when the application voltage to the liquid crystal is to be set at the negative polarity, the first-period opposing electrode voltage Vω is set at the negative polarity with respect to the center of the amplitude of the source voltage, so that the polarity of the source voltage becomes positive (during the first period) with respect to the first-period opposing electrode voltage Vω. After such a source voltage is provided to the pixel electrode 21 during the first period, during the second period, the opposing electrode voltage is caused to change to the positive polarity and also the voltage on the auxiliary capacitance line Ck is caused to change to the negative polarity. As a result, the voltage of the negative polarity is applied to the liquid crystal.

Note that, during a period after the voltage on the auxiliary capacitance line Ck is caused to change but before the end of the second period, the voltage on the auxiliary capacitance line Ck is preferably caused to change in accordance with (in the same polarity direction as) the change of the opposing electrode voltage. As a result, the amount of charge to be redistributed between the auxiliary capacitance 23 and the liquid crystal capacitance 22 decreases, so that a stable voltage (a less fluctuating voltage) is applied to the liquid crystal. Also, it may be configured such that, through the period before the end of the second period, instead of changing the voltage of the auxiliary capacitance line Ck in accordance with the change of the opposing electrode voltage, the charge may be controlled not to flow into the auxiliary capacitance line Ck and the charge may be controlled not to flow out of the auxiliary capacitance line Ck. As a result, the auxiliary capacitance line Ck is brought into a state of being electrically floating (floating state). The pixel electrode 21 is capacitively coupled to each of the opposing electrode 24 and the auxiliary capacitance line Ck, and therefore the pixel electrode voltage changes in accordance with the change of the opposing electrode voltage, so that the voltage on the auxiliary capacitance line Ck changes in accordance with the change of the pixel electrode voltage.

As a result, a stable voltage is applied to the liquid crystal.

### 1.3 Common Features of the First and Second Configurations

In the aforementioned period from the start point of the first period to the change of the voltage on the auxiliary capacitance line Ck during the second period, the liquid crystal has applied thereto a voltage different from the voltage that is supposed to be applied. As a result, the voltage applied to the liquid crystal during that period causes the difference in effective value voltages between full-white voltage and full-black voltage to be smaller than it is supposed to be. However, in the case of a display device having, for example, hundreds or more of gate lines, even if the liquid crystal has applied thereto a voltage different from the voltage that is supposed to be applied during the aforementioned period, the difference in effective value voltage between full-white voltage and full-black voltage does not decrease significantly. Therefore, instead of driving (a plurality of) auxiliary capacitance lines independently of one another, the auxiliary capacitance lines may be driven with a predetermined number of them being short-circuited at a time. This results in a reduced scale of the circuit for driving the auxiliary capacitance lines.

Hereinafter, embodiments of the present invention will be described with reference to the accompanying drawings.

### 2. First Embodiment

### 2.1 Overall Configuration and Operation

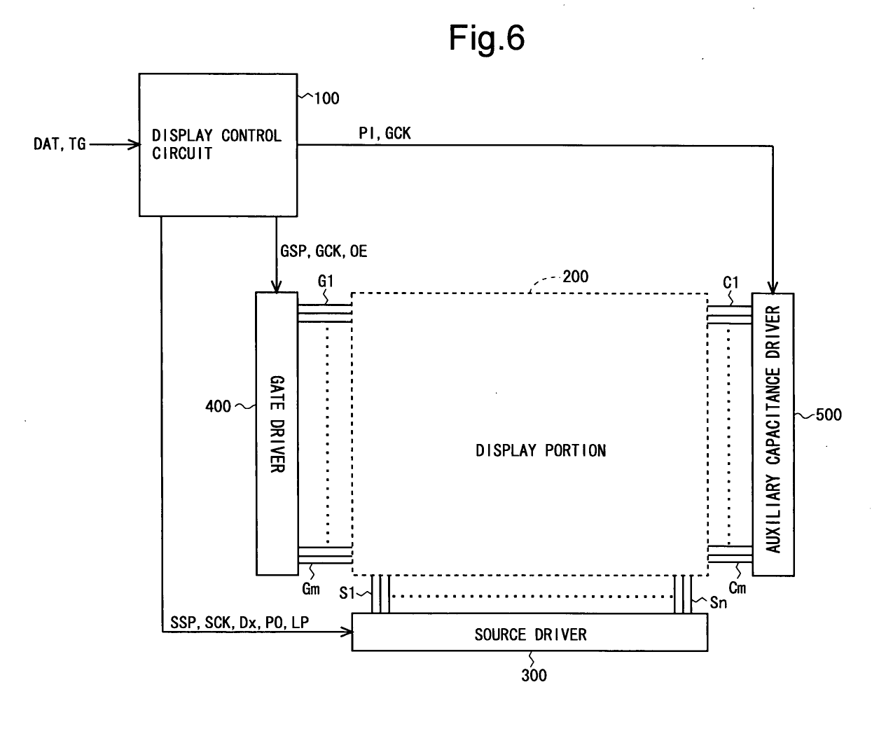

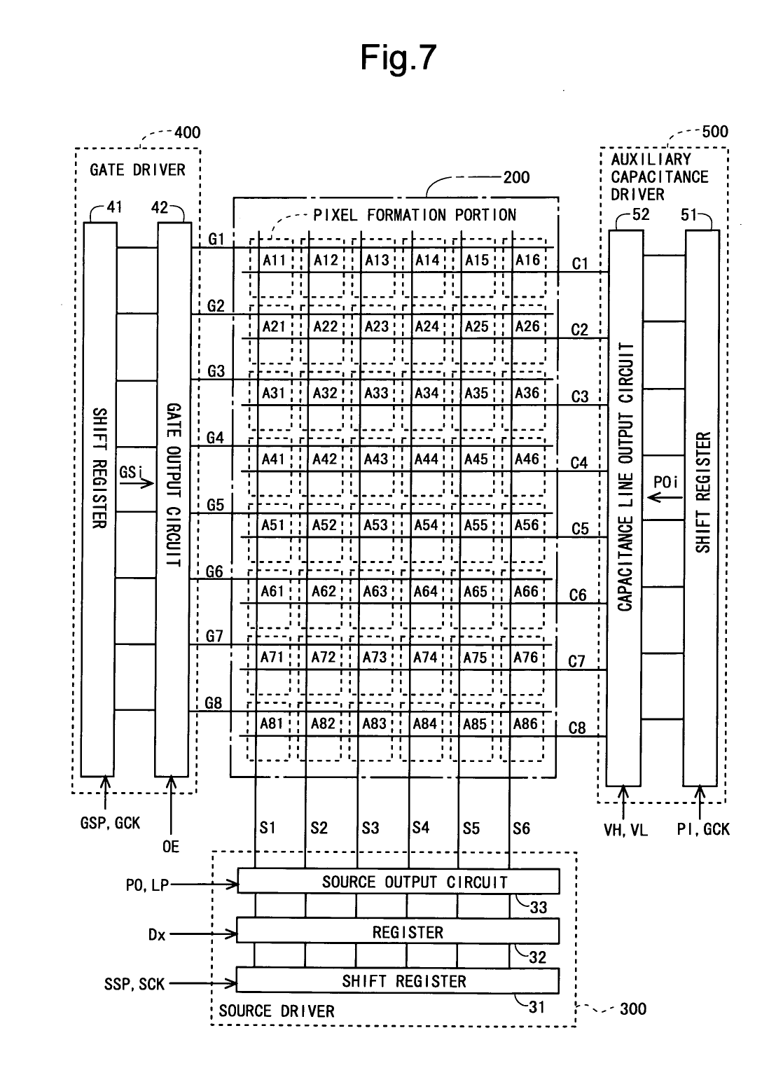

FIG. 6 is a block diagram illustrating the overall configuration of a liquid crystal display device according to a first embodiment of the present invention. The liquid crystal display device includes a display control circuit 100, a display portion 200, a source driver (video signal line driver circuit) 300, a gate driver (scanning signal line driver circuit) 400, and an auxiliary capacitance driver (auxiliary capacitance electrode driver circuit) 500. In the following descriptions, the source driver 300, the gate driver 400, and the auxiliary capacitance driver 500 are also collectively referred to as drivers (driver circuits). FIG. 7 is a block diagram illustrating detailed configurations of the drivers and the display portion 200 in the liquid crystal display device. Note that descriptions will be provided on the assumption that a 256 gray-scale gradation display is performed in the liquid crystal display device.

The display portion 200 includes n source lines (video signal lines) S1 to Sn, m gate lines (scanning signal lines) G1 to Gm, and a plurality (n×m) of pixel formation portions provided at their corresponding intersections of the n source lines and the m gate lines. Also, the display portion 200 has m auxiliary capacitance lines C1 to Cm provided corresponding to the gate lines G1 to Gm. While a pixel matrix of m rows×n columns is formed by the pixel formation portions, FIG. 7 only shows a configuration of eight rows×six columns. Also, in FIG. 7, a pixel formation portion arranged in the i'th row, j'th column is assigned reference character Aij.

FIG. 8 is a circuit diagram illustrating the configuration of the pixel formation portion Aij. As shown in FIG. 8, each pixel formation portion Aij includes a TFT 20 as a switching element having a gate electrode 25 connected to a gate line Gi passing through a corresponding intersection and a source electrode 26 connected to a source line Si passing through the intersection; a pixel electrode 21 connected to a drain electrode 27 of the TFT 20; an opposing electrode (common electrode) 24 and an auxiliary capacitance line (auxiliary capacitance electrode) Ck commonly provided for a plurality of pixel formation portions Aij; a liquid crystal capacitance 22 as an element capacitance formed by the pixel electrode 21 and the opposing electrode 24; and an auxiliary capacitance 23 formed by the pixel electrode 21 and the auxiliary capacitance line Ck. Also, a pixel capacitance Cp is formed by the liquid crystal capacitance 22 and the auxiliary capacitance 23. Furthermore, a voltage indicating a pixel value is retained in the pixel capacitance Cp based on a video signal received by the source electrode 26 of the TFT 20 through the source line Si when the gate electrode 25 of the TFT 20 receives an active scanning signal (selection signal) from the gate line Gi.

Next, referring to FIG. 6, the operation of each component will be outlined. The display control circuit 100 receives a data signal DAT and a timing control signal group TG, which are externally transmitted, and outputs a digital video signal Dx, along with a source start pulse signal SSP, a source clock signal SCK, a gate start pulse signal GSP, a gate clock signal GCK, a latch pulse signal LP, a source polarity signal PO, an auxiliary capacitance line polarity signal PI, and a gate output control signal OE, which are intended to control the timing of displaying an image on the display portion 200 and the application voltage to the liquid crystal.

The source driver 300 receives the digital video signal Dx, the source start pulse signal SSP, the source clock signal SCK, the source polarity signal PO and the latch pulse signal LP, which are outputted by the display control circuit 100, and applies a drive video signal to the source lines S1 to Sn to charge the pixel capacitance Cp of each pixel formation portion Aij in the display portion 200. The gate driver 400 receives the gate start pulse signal GSP, the gate clock signal GCK and the gate output control signal OE, which are outputted by the display control circuit 100, and sequentially applies a selection signal (scanning signal) to the gate lines G1 to Gm. The auxiliary capacitance driver 500 receives the auxiliary capacitance line polarity signal PI and the gate clock signal GCK, which are outputted by the display control circuit 100, and applies an auxiliary capacitance line drive signal to the auxiliary capacitance lines C1 to Cm.

In this manner, the drive video signal is applied to each of the source lines S1 to Sn, the selection signal is applied to each of the gate lines G1 to Gm, and the auxiliary capacitance line drive signal is applied to each of the auxiliary capacitance lines C1 to Cm, so that an image is displayed on the display portion 200.

### 2.2 Configuration and Operation of the Source Driver

As shown in FIG. 7, the source driver 300 includes a shift register 31, a register 32, and a source output circuit 33. Note that the shift register 31 is composed of n bits (n stages), and the register 32 is composed of “n×8” bits. Also, the source output circuit 33 has n 8-bit latches and n D/A conversion circuits.

A source start pulse signal SSP and a source clock signal SCK are inputted into the shift register 31. Based on the signals SSP and SCK, the shift register 31 sequentially transfers pulses contained in the source start pulse signal SSP from input terminal to output terminal. In accordance with the pulse transfer, sampling pulses corresponding to the source lines S1 to Sn are sequentially outputted from the shift register 31, and the sampling pulses are sequentially inputted into the register 32.

The register 32 samples 8-bit data transmitted from the display control circuit 100 as a digital video signal Dx in accordance with the timing of the sampling pulses outputted from the shift register 31, and retains the 8-bit data. The source output circuit 33 loads n pieces of 8-bit data retained in the register 32 into n 8-bit latches in accordance with the timing of the pulses of the latch pulse signal LP, and performs digital-analog conversion on them through the D/A conversion circuit. Furthermore, the source output circuit 33 applies the data subjected to digital-analog conversion to the source lines S1 to Sn as a drive video signal. At this time, the polarity of the drive video signal is determined based on the source polarity signal PO.

### 2.3 Configuration and Operation of the Gate Driver

As shown in FIG. 7, the gate driver 400 includes a shift register 41 and a gate output circuit 42. Note that the shift register 41 is composed of m bits (m stages). A gate start pulse signal GSP and a gate clock signal GCK are inputted into the shift register 41. Based on the signals GSP and GCK, the shift register 41 sequentially transfers pulses contained in the gate start pulse signal GSP from input terminal to output terminal. In accordance with the pulse transfer, timing pulses GSi corresponding to the gate lines G1 to Gm are sequentially outputted from the shift register 41, and the timing pulses GSi are sequentially inputted into the gate output circuit 42.

Based on the timing pulses GSi outputted from the shift register 41 and a gate output control signal OE outputted from the display control circuit 100, the gate output circuit 42 outputs selection signals G1 to Gm to the gate lines G1 to Gm (for the sake of convenience, the gate lines and the selection signals are denoted by the same reference characters).

### 2.4 Configuration and Operation of the Auxiliary Capacitance Driver

As shown in FIG. 7, the auxiliary capacitance driver 500 includes a shift register 51 and a capacitance line output circuit 52. Note that the shift register 51 is composed of m bits (m stages). An auxiliary capacitance line polarity signal PI and a gate clock signal GCK are inputted into the shift register 51. The auxiliary capacitance line polarity signal PI is sequentially transferred within the shift register 51 based on the gate clock signal GCK. In accordance with the transfer of the auxiliary capacitance line polarity signal PI, polarity signals POi corresponding to the auxiliary capacitance lines C1 to Cm are sequentially outputted from the shift register 51, and the polarity signals POi are inputted into the capacitance line output circuit 52.

Based on the polarity signals POi outputted from the shift register 51, the capacitance line output circuit 52 outputs either a predetermined positive-polarity voltage VH or a predetermined negative-polarity voltage VL to the auxiliary capacitance lines C1 to Cm as auxiliary capacitance drive signals C1 to Cm (for the sake of convenience, the auxiliary capacitance lines and the auxiliary capacitance drive signals are denoted by the same reference characters).

### 2.5 Drive Method

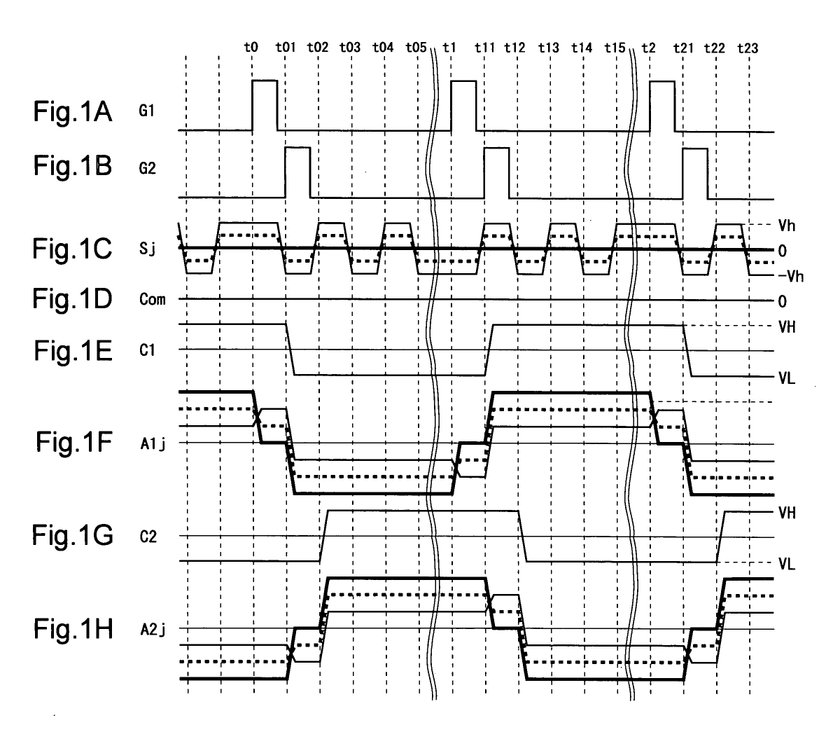

FIG. 1 is a signal waveform diagram describing the drive method of the present embodiment. FIGS. 1A to 1H respectively illustrating waveforms of a scanning signal applied to the first-row gate line G1, a scanning signal applied to the second-row gate line G2, a voltage (source voltage) applied to the source line Sj, a voltage on the opposing electrode 24, an auxiliary capacitance line drive signal applied to the first-row auxiliary capacitance line C1, a pixel electrode voltage on the first-row pixel formation portion A1j, an auxiliary capacitance line drive signal applied to the second-row auxiliary capacitance line C2, and a pixel electrode voltage on the second-row pixel formation portion A2j. Note that in FIG. 1, the period from point t0 to point t1 corresponds to one frame period.

The meanings of lines in FIGS. 1C, 1F, and 1H are as follows. Thick solid lines represent waveforms of voltage corresponding to an input signal Dx having a gray-scale value of “255”. Thick dotted lines represent waveforms of voltage corresponding to an input signal Dx having a gray-scale value of “128”. Thin solid lines represent waveforms of voltage corresponding to an input signal Dx having a gray-scale value of “0”.

Focusing on the first-row pixel formation portion A1j, the period from point t0 to point t01 within aforementioned one frame period corresponds to the first period, and the period from point t01 to point t1 corresponds to the second period. Also, the period from point t1 to point t11 within the next frame period corresponds to the first period, and the period from point t11 to point t2 corresponds to the second period. For the second-row pixel formation portion A2j, the start and end points of the first and second periods are delayed by one horizontal scanning period from those of the first-row pixel formation portion A1j. That is, the period from point t01 to point t02 corresponds to the first period, and the period from point t02 to point t11 corresponds to the second period. Also, the period from point t11 to point t12 within the next frame period corresponds to the first period, and the period from point t12 to point t21 corresponds to the second period.

Incidentally, the liquid crystal has characteristics of deteriorating when direct-current voltage is continuously applied thereto. Accordingly, in the liquid crystal display device, alternating-current voltage must be applied to the liquid crystal. Therefore, in the present embodiment, focusing on one pixel formation portion, operation varies between the n'th frame (where n is a natural number) and the (n+1)'th frame. For example, the polarity of the voltage applied to the source line Sj or the auxiliary capacitance line Ck is reversed between the frame period from point t0 to point t1 and the frame period from point t1 to point t2.

Referring to FIGS. 1 and 2, the drive method of the present embodiment will be described. Note that the descriptions will be provided here on the assumption that the polarity of the target voltage Vβ for the first-row pixel formation portion A1j is negative during the frame period from point t0 to point t1.

<2.5.1 About the First-Row Pixel Formation Portion>

First, focus is placed on the first-row pixel formation portion A1j. During the period from point t0 to point t01, a selection voltage (a voltage bringing the gate of the TFT 20 into conductive state) is applied to the first-row gate line G1. Also, during this period, the first-period pixel electrode voltage Vμ having a value calculated based on equation (11) is applied to the source line Sj. Here, since the target voltage Vβ is assumed to have the negative polarity, the first-period pixel electrode voltage Vμ has the positive polarity. The magnitude of the first-period pixel electrode voltage Vμ (the absolute voltage value) is set in the range from 0 to Vh (hereinafter, Vh is referred to as a “source high voltage”). As a result, the first-period pixel electrode voltage Vμ in the range from 0V to Vh is applied to the pixel electrode 21 of the pixel formation portion A1j in accordance with the magnitude of the target voltage Vβ. Note that for the first-period pixel electrode voltage Vμ, when a gray-scale value which the input signal Dx indicates is “0”, the absolute voltage value is maximized, i.e., to the source high voltage, and when a gray-scale value which the input signal Dx indicates is “255”, the absolute voltage value is minimized, i.e., to 0V. Also, during this period, a predetermined high-potential voltage (hereinafter, referred to as an “auxiliary capacitance line high voltage”) VH is applied to the first-row auxiliary capacitance line C1. The opposing electrode 24 is fixed at ground potential during an operation of the liquid crystal display device.

During the period from point t₀₁ to point t1, a non-selection voltage (a voltage that brings the gate of the TFT 20 into non-conductive state) is applied to the first-row gate line G1. Also, at point t01, the voltage applied to the first-row auxiliary capacitance line C1 is caused to change from the auxiliary capacitance line high voltage VH to a predetermined low-potential voltage (hereinafter, referred to as an “auxiliary capacitance line lowvoltage”) VL. Since the pixel electrode 21 and the auxiliary capacitance line Ck are capacitively coupled, the potential of the pixel electrode 21 in the pixel formation portion A1j falls as shown in FIG. 1F in accordance with the fall of the voltage on the auxiliary capacitance line C1. Thereafter, a voltage equivalent to the potential difference between the pixel electrode 21 and the opposing electrode 24 is applied to the liquid crystal.

Incidentally, in the present embodiment, the auxiliary capacitance line high voltage VH and the auxiliary capacitance line low voltage VL are preset such that a voltage of “−V₂₅₅” is applied to the liquid crystal when the liquid crystal capacitance value is in steady state at C₂₅₅ through the first and second periods and the first-period pixel electrode voltage Vμ, the first-period opposing electrode voltage Vω and the second-period opposing electrode voltage Vθ are all 0V. Specifically, the auxiliary capacitance line high voltage VH and the auxiliary capacitance line low voltage VL are set such that the following equation is established based on equation (9).

$$\begin{matrix}[ Eq . 13 ] & \\ \begin{matrix}\begin{matrix}- {V}_{255} = Vy - V θ \\ = \frac{C α ( V μ - V ω ) + Cs ( V μ - V θ + Vb - Va )}{Cy + Cs} \\ = \frac{C α ( 0 V - 0 V ) + Cs ( 0 V - 0 V + Vb - Va )}{{C}_{255} + Cs} \\ = \frac{Cs ( VL - VH )}{{C}_{255} + Cs}\end{matrix} \\ ∴ VH - VL = \frac{( {C}_{255} + Cs ) {V}_{255}}{Cs}\end{matrix} & ( 13 )\end{matrix}$$

Note that when the settings of the auxiliary capacitance line high voltage VH and the auxiliary capacitance line low voltage VL are limited in some way, the auxiliary capacitance value Cs may be set such that equation (13) is established.

By performing the above-described drive, for the pixel formation portion provided with a voltage of 0V as the first-period pixel electrode voltage Vμ, the second-period pixel electrode voltage Vy is expressed by the following equation based on equations (7) and (13).

$$[ Eq . 14 ]$$

$$\begin{matrix}Vy = \frac{( C α + Cs ) V μ + ( CyV θ - C α V ω ) + Cs ( Vb - Va )}{Cy + Cs} \\ = \frac{\begin{matrix}( C α + Cs ) 0 V + ( Cy \times 0 V - C α \times 0 V ) + \\ Cs ( VL - VH )\end{matrix}}{Cy + Cs} \\ = \frac{- ( {C}_{255} + Cs ) {V}_{255}}{Cy + Cs}\end{matrix} \qquad ( 14 )$$

From equation (14), “|Vy|=|V₂₅₅|” is established when “Cy=Cα” and “Cα=C₂₅₅”, i.e., when the liquid crystal capacitance value is in steady state at C₂₅₅ through the first and second periods. Also, “|VY|>|V₂₅₅|” is established when “Cα<Cy” and “Cy<C₂₅₅”, i.e., when the liquid crystal capacitance value is in such a transition state as to change from low value to high value.

For the pixel formation portion provided with a positive-polarity source high voltage Vh as the first-period pixel electrode voltage Vμ, the second-period pixel electrode voltage Vy is expressed by the following equation based on equations (7) and (13).

$$\begin{matrix}[ Eq . 15 ] & \\ \begin{matrix}Vy = \frac{( C α + Cs ) V μ + ( CyV θ - C α V ω ) + Cs ( Vb - Va )}{Cy + Cs} \\ = \frac{( C α + Cs ) Vh + ( Cy \times 0 V - C α \times 0 V ) + Cs ( VL - VH )}{Cy + Cs} \\ = \frac{( C α + Cs ) Vh - ( {C}_{255} + Cs ) {V}_{255}}{Cy + Cs}\end{matrix} & ( 15 )\end{matrix}$$

Here, the source high voltage Vh is set such that the following equation is set based on equation (15) when “Cy=Cα” and “Cα=C₀”, i.e., when the liquid crystal capacitance value is in steady state at C₀ through the first and second periods.

$$[ Eq . 16 ]$$

$$\begin{matrix}Vy = \frac{( {C}_{0} + Cs ) Vh - ( {C}_{255} + Cs ) {V}_{255}}{{C}_{0} + Cs} \\ = - {V}_{0}\end{matrix} \qquad ( 16 )$$

From equation (16), the source high voltage Vh is expressed by the following equation.

$$\begin{matrix}[ Eq . 17 ] & \\ ( {C}_{0} + Cs ) Vh = - ( {C}_{0} + Cs ) {V}_{0} + ( {C}_{255} + Cs ) {V}_{255} \\ ∴ Vh = - {V}_{0} + \frac{( {C}_{255} + Cs ) {V}_{255}}{{C}_{0} + Cs} & ( 17 )\end{matrix}$$

Also, when “Cα>Cy” and “Cy>C₀”, i.e., when the liquid crystal capacitance value is in such a transition state as to change from high value to low value, equation (15) is transformed as follows.

$$[ Eq . 18 ]$$

$$\begin{matrix}Vy = \frac{( C α + Cs ) Vh - ( {C}_{255} + Cs ) {V}_{255}}{Cy + Cs} \\ = \frac{\begin{matrix}( C α + Cs ) ( \frac{- {V}_{0} + ( {C}_{255} + Cs ) {V}_{255}}{( {C}_{0} + Cs )} ) - \\ ( {C}_{255} + Cs ) {V}_{255}\end{matrix}}{Cy + Cs} \\ = \frac{\begin{matrix}- ( C α + Cs ) ( {C}_{0} + Cs ) {V}_{0} + \\ ( C α + Cs ) ( {C}_{255} + Cs ) {V}_{255} - \\ ( {C}_{0} + Cs ) ( {C}_{255} + Cs ) {V}_{255}\end{matrix}}{( Cy + Cs ) ( {C}_{0} + Cs )} \\ = \frac{\begin{matrix}- ( C α + Cs ) ( {C}_{0} + Cs ) {V}_{0} + \\ ( C α - {C}_{0} ) ( {C}_{255} + Cs ) {V}_{255}\end{matrix}}{( Cy + Cs ) ( {C}_{0} + Cs )} \\ = \frac{\begin{matrix}- ( Cy + Cs ) ( {C}_{0} + Cs ) {V}_{0} + ( Cy - C α ) ( {C}_{0} + Cs ) {V}_{0} + \\ ( C α - Cy ) ) ( {C}_{255} + Cs ) {V}_{255} + \\ ( Cy - {C}_{0} ) ( {C}_{255} + Cs ) {V}_{255}\end{matrix}}{( Cy + Cs ) ( {C}_{0} + Cs )} \\ = - {V}_{0} + \frac{( C α - Cy ) ( \begin{matrix}( {C}_{255} + Cs ) {V}_{255} - \\ ( {C}_{0} + Cs ) {V}_{0}\end{matrix} )}{( Cy + Cs ) ( {C}_{0} + Cs )} + \\ \frac{( Cy - {C}_{0} ) ( {C}_{255} + Cs ) {V}_{255}}{( Cy + Cs ) ( {C}_{0} + Cs )}\end{matrix} \qquad ( 18 )$$

For equation (18), the second term on the right-hand side (in the last row) is positive because “Cα>Cy” and “C₂₅₅>C₀”. The third term is also positive because “Cy>C₀”. The first term is negative. Thus, “|Vy|<|V₀|” is established.

<2.5.2 About the Second-Row Pixel Formation Portion>

Next, focus is placed on the second-row pixel formation portion A2j. For the second-row pixel formation portion A2j, the period from point t01 to point t02 corresponds to the first period. During the period from point t01 to point t02, a selection voltage is applied to the second-row gate line G2. As a result, the TFT 20 is brought into conductive state. Also, during this period, the first-period pixel electrode voltage Vμ having a value calculated based on equation (11) is applied to the source line Sj. Here, the target voltage Vβ for the second-row pixel formation portion A2j and the target voltage Vβ for the first-row pixel formation portion A1j are in opposite polarities, and therefore the first-period pixel electrode voltage Vμ for the second-row pixel formation portion A2j has the negative polarity. The magnitude of the first-period pixel electrode voltage Vμ (the absolute voltage value) is set in the range from 0 to Vh. Thus, the first-period pixel electrode voltage Vμ in the range from −Vh to 0V is applied to the pixel electrode 21 of the pixel formation portion A2j in accordance with the magnitude of the target voltage Vβ. Note that for the first-period pixel electrode voltage Vμ, when a gray-scale value which the input signal Dx indicates is “0”, the absolute voltage value is maximized, i.e., to the source high voltage, and when a gray-scale value which the input signal Dx indicates is “255”, the absolute voltage value is minimized, i.e., to 0V. Also, during this period, the auxiliary capacitance line low voltage VL is applied to the second-row auxiliary capacitance line C2.

During the period from point t02 to point t11, a non-selection voltage is applied to the second-row gate line G2. As a result, the TFT 20 is brought into non-conductive state. Also, at point t02, the voltage applied to the second-row auxiliary capacitance line C2 is caused to change from the auxiliary capacitance line low voltage VL to the auxiliary capacitance line high voltage VH. Accordingly, the potential of the pixel electrode 21 in the pixel formation portion A2j rises as shown in FIG. 1H. Then, a voltage equivalent to the potential difference between the pixel electrode 21 and the opposing electrode 24 is applied to the liquid crystal.

By performing the above-described drive, for the pixel formation portion provided with a voltage of 0V as the first-period pixel electrode voltage Vμ, the second-period pixel electrode voltage Vy is expressed by the following equation based on equations (7) and (13).

$$[ Eq . 19 ]$$

$$\begin{matrix}Vy = \frac{( C α + Cs ) V μ + ( CyV θ - C α V ω ) + Cs ( Vb - Va )}{Cy + Cs} \\ = \frac{( C α + Cs ) \times 0 V + ( Cy \times 0 V - C α \times 0 V ) + Cs ( VH - VL )}{Cy + Cs} \\ = \frac{( {C}_{255} + Cs ) {V}_{255}}{Cy + Cs}\end{matrix} \qquad ( 19 )$$

From equation (19), “|Vy|=|V₂₅₅|” is established when “Cy=C₂₅₅” and “Cα=C₂₅₅”, i.e., when the liquid crystal capacitance value is in steady state at C₂₅₅ through the first and second periods. Also, “|VY|>|V₂₅₅|” is established when “Cα<Cy” and “Cy<C₂₅₅”, i.e., when the liquid crystal capacitance value is in such a transition state as to change from low value to high value.

For the pixel formation portion provided with a negative-polarity source high voltage “−Vh” as the first-period pixel electrode voltage V_{μ}, the second-period pixel electrode voltage Vy is expressed by the following equation based on equations (7) and (19).

$$[ Eq . 20 ]$$

$$\begin{matrix}Vy = \frac{( C α + Cs ) V μ + ( CyV θ - C α V ω ) + Cs ( Vb - Va )}{Cy + Cs} \\ = \frac{( C α + Cs ) ( - Vh ) + ( Cy \times 0 V - C α \times 0 V ) + Cs ( VH - VL )}{Cy + Cs} \\ = \frac{- ( C α + Cs ) Vh + ( {C}_{255} + Cs ) {V}_{255}}{Cy + Cs} \\ = \frac{( C α + Cs ) ( \frac{\begin{matrix}{V}_{0} - \\ ( {C}_{255} + Cs ) {V}_{255}\end{matrix}}{( {C}_{0} + Cs )} ) + ( {C}_{255} + Cs ) {V}_{255}}{Cy + Cs} \\ = \frac{\begin{matrix}( C α + Cs ) ( {C}_{0} + Cs ) {V}_{0} - ( C α + Cs ) ( {C}_{255} + Cs ) {V}_{255} + \\ ( {C}_{0} + Cs ) ( {C}_{255} + Cs ) {V}_{255}\end{matrix}}{( Cy + Cs ) ( {C}_{0} + Cs )} \\ = \frac{( C α + Cs ) ( {C}_{0} + Cs ) {V}_{0} + ( {C}_{0} - C α ) ( {C}_{255} + Cs ) {V}_{255}}{( Cy + Cs ) ( {C}_{0} + Cs )} \\ = \frac{\begin{matrix}( Cy + Cs ) ( {C}_{0} + Cs ) {V}_{0} + ( C α - Cy ) ( {C}_{0} + Cs ) {V}_{0} + \\ ( {C}_{0} - Cy ) ( {C}_{255} + Cs ) {V}_{255} + \\ ( Cy - C α ) ( {C}_{255} + Cs ) {V}_{255}\end{matrix}}{( Cy + Cs ) ( {C}_{0} + Cs )} \\ = {V}_{0} - \frac{( C α - Cy ) ( ( {C}_{255} + Cs ) {V}_{255} - ( {C}_{0} + Cs ) {V}_{0} )}{( {C}_{0} + Cs ) ( Cy + Cs )} - \\ \frac{( Cy - {C}_{0} ) ( {C}_{255} + Cs ) {V}_{255}}{( {C}_{0} + Cs ) ( Cy + Cs )}\end{matrix} \qquad ( 20 )$$

Here, “Vy=V₀” is established when “Cy=Cα” and “Cα=C₀”, i.e., when the liquid crystal capacitance value is in steady state at C₀ through the first and second periods. Also, “|Vy|<|V₀|” is established when “Cα>Cy” and “Cy>C₀”, i.e., when the liquid crystal capacitance value is in such a transition state as to change from high value to low value.

### 2.6 Effect

According to the present embodiment, when a target voltage Vβ of one polarity with respect to the opposing electrode voltage is to be applied to the pixel electrode 21 during a certain frame period, a voltage of the other polarity with respect to the opposing electrode voltage is applied to the pixel electrode 21 during the first period of that frame period. Then, during the second period of the frame period, the voltage on the auxiliary capacitance line Ck is caused to change from the voltage of the other polarity to the voltage of one polarity with the TFT 20 being in non-conductive state. As a result, a voltage of one polarity is applied to the pixel electrode 21. At this time, “|Vy|>|Vβ|” is established when the liquid crystal capacitance value is in such a transition state as to change from low value to high value, as described above. That is, a voltage above the target voltage is applied to the liquid crystal during the transition period. Also, “|Vy|<|Vβ|” is established when the liquid crystal capacitance value is in such a transition state as to change from high value to low value. That is, a voltage below the target voltage is applied to the liquid crystal during the transition period.

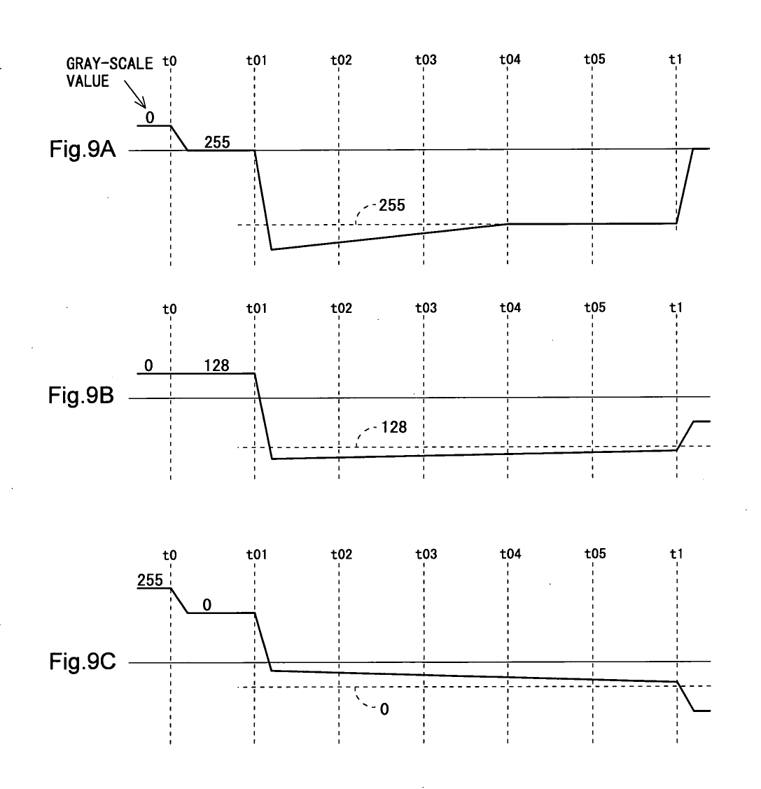

For example, when the gray-scale value in the previous frame is “0” and the gray-scale value in the current frame is “255”, the pixel electrode voltage changes as shown in FIG. 9A. Also, when the gray-scale value in the previous frame is “0” and the gray-scale value in the current frame is “128”, the pixel electrode voltage changes as shown in FIG. 9B. In this manner, when a transition state occurs such that the liquid crystal capacitance value changes from low value to high value, a voltage above the target voltage is applied to the liquid crystal, resulting in an improved liquid crystal response speed. Here, comparing FIGS. 9A and 9B, it can be appreciated that the voltage above the target voltage that is applied to the liquid crystal is greater in the case where the gray-scale value changes from “0” to “255” than in the case where the gray-scale value changes from “0” to “128”. In this manner, the voltage above the target voltage that is applied to the liquid crystal becomes greater as the change of the liquid crystal capacitance value increases, and therefore the liquid crystal response speed can be improved effectively. Also, when the gray-scale value in the previous frame is “255” and the gray-scale value in the current frame is “0”, the pixel electrode voltage changes as shown in FIG. 9C. In this manner, when a transition state occurs such that the liquid crystal capacitance value changes from high value to low value, a voltage below the target voltage is applied to the liquid crystal, resulting in an improved liquid crystal response speed.

Also, in the present embodiment, frame memory for retaining information indicating the immediately previous state of display is not provided as a component for obtaining an overdrive voltage (overshoot voltage).

As described above, according to the present embodiment, the (liquid crystal) response speed is improved without incorporating frame memory in the liquid crystal display device.

### 3. Second Embodiment

### 3.1 Configuration

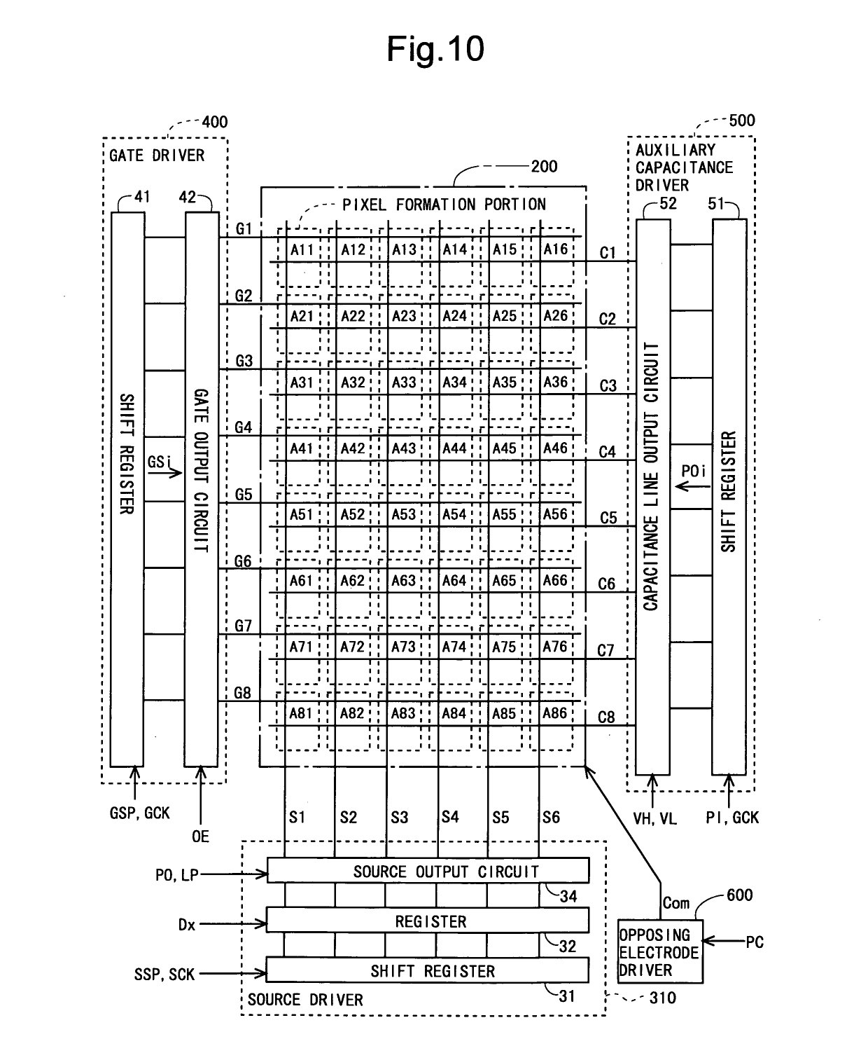

FIG. 10 is a block diagram illustrating detailed configurations of drivers and a display portion 200 in a liquid crystal display device according to a second embodiment of the present invention. In the present embodiment, an opposing electrode driver 600 for driving an opposing electrode 24 is provided, along with components in the first embodiment. Also, the source output circuit in the source driver is configured differently from that of the first embodiment. Other components are the same as those of the first embodiment, and therefore any descriptions thereof will be omitted.

The opposing electrode driver 600 is provided with an opposing electrode polarity signal PC from the display control circuit 100. The opposing electrode driver 600 drives the opposing electrode 24 based on the opposing electrode polarity signal PC. Specifically, the opposing electrode driver 600 provides the opposing electrode 24 with a voltage of 0V alternating with a source high voltage Vh as described above (in the first embodiment) every horizontal scanning period. In this manner, in the present embodiment, unlike in the first embodiment, the high-potential voltage and the low-potential voltage are alternatingly provided to the opposing electrode 24.

A source output circuit 34 in the source driver 310 loads n pieces of 8-bit data retained in a register 32 therein with the timing of pulses of a latch pulse signal LP, and applies the data subjected to digital-analog conversion to the source lines S1 to Sn as drive video signals based on a source polarity signal PO. Here, in the first embodiment, a voltage in the range of “−V₂₅₅ to V₂₅₅” is applied from the source output circuit 33 to the source line Sj, but in the present embodiment, a voltage in the range of “0V to V₂₅₅” is applied from the source output circuit 34 to the source line Sj.

### 3.2 Drive Method

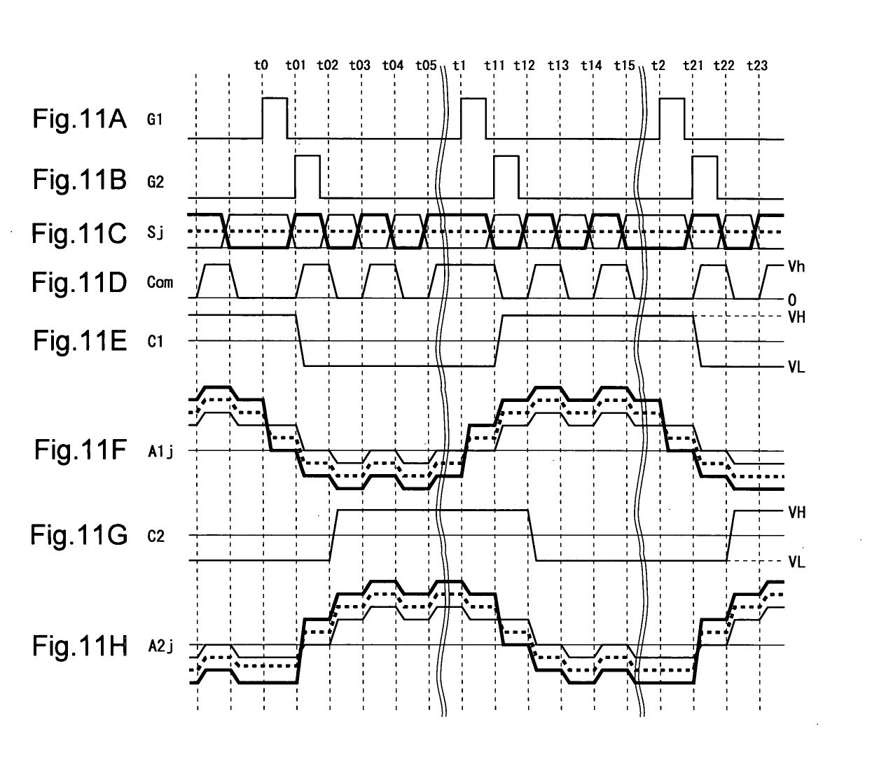

FIG. 11 is a signal waveform diagram describing the drive method of the present embodiment. The meanings of lines in FIGS. 11C, 11F, and 11H are the same as those of the lines in FIGS. 1C, 1F, and 1H for the first embodiment. Note that the present embodiment will be also described on the assumption that the target voltage Vβ for the first-row pixel formation portion A1j has the negative polarity during the frame period from point t0 to point t1.

<3.2.1 About the First-Row Pixel Formation Portion>

First, focus is placed on the first-row pixel formation portion A1j. During the period from point t0 to point t01, a selection voltage is applied to the first-row gate line G1. As a result, the TFT 20 is brought into conductive state. Also, during this period, an opposing electrode voltage Com is set at 0V. Furthermore, during this period, the first-period pixel electrode voltage Vμ having a value calculated based on equation (11) is applied to the source line Sj. While a voltage in the range from 0V to V₂₅₅ is applied to the source line Sj as the first-period pixel electrode voltage Vμ in the present embodiment, during this period, when a gray-scale value which the input signal Dx indicates is “0”, the first-period pixel electrode voltage Vμ is set at V₂₅₅, and when a gray-scale value which the input signal Dx indicates is “255”, the first-period pixel electrode voltage Vμ is set at 0V. As a result, the first-period pixel electrode voltage Vμ in the range from 0V to V₂₅₅ is applied to the pixel electrode 21 of the pixel formation portion A1j in accordance with the magnitude of the target voltage Vβ. Note that during this period, the auxiliary capacitance line high voltage VH is applied to the first-row auxiliary capacitance line C1.

During the period from point t01 to point t1, a non-selection voltage is applied to the first-row gate line G1. As a result, the TFT 20 is brought into non-conductive state. Also, at point t01, the opposing electrode voltage Com is caused to change from 0V to the source high voltage Vh, and the voltage applied to the first-row auxiliary capacitance line C1 is caused to change from the auxiliary capacitance line high voltage VH to the auxiliary capacitance line low voltage VL. As a result, the pixel electrode voltage of the pixel formation portion A1j is set in the range from “−V₂₅₅ to 0V”.

Incidentally, in the present embodiment, the auxiliary capacitance line high voltage VH and the auxiliary capacitance line low voltage VL are preset such that a voltage of “−V₂₅₅” is applied to the liquid crystal when the liquid crystal capacitance value is in steady state at C₂₅₅ through the first and second periods and “the first-period pixel electrode voltage Vμ is 0V”, “the first-period opposing electrode voltage Vω is 0V”, and “the second-period opposing electrode voltage Vθ is the source high voltage Vh”. Specifically, the auxiliary capacitance line high voltage VH and the auxiliary capacitance line low voltage VL are set based on equation (9) such that the following equation is established.

$$[ Eq . 21 ]$$

$$\begin{matrix}- {V}_{255} = Vy - V θ \\ = \frac{C α ( V μ - V ω ) + Cs ( V μ - V θ + Vb - Va )}{Cy + Cs} \\ = \frac{C α ( 0 V - 0 V ) + Cs ( 0 V - Vh + VL - VH )}{{C}_{255} + Cs} \\ = \frac{Cs ( - Vh + VL - VH )}{{C}_{255} + Cs}\end{matrix} \\ ∴ VH - VL + Vh = \frac{( {C}_{255} + Cs ) {V}_{255}}{Cs} \qquad ( 21 )$$

Note that when the settings of the auxiliary capacitance line high-voltage VH and the auxiliary capacitance line low voltage VL are limited in some way, the auxiliary capacitance value Cs may be set such that equation (21) is established.

By performing the above-described drive, for the pixel formation portion provided with a voltage of 0V as the first-period pixel electrode voltage Vμ, the liquid crystal application voltage “Vy−Vθ” during the second period is expressed by the following equation based on equations (8) and (21).

$$[ Eq . 22 ]$$

$$\begin{matrix}Vy - V θ = \frac{C α ( V μ - V ω ) + Cs ( V μ - V θ + Vb - Va )}{Cy + Cs} \\ = \frac{C α ( 0 V - 0 V ) + Cs ( 0 V - Vh + VL - VH )}{Cy + Cs} \\ = \frac{( {C}_{255} + Cs ) {V}_{255}}{Cy + Cs}\end{matrix} \qquad ( 22 )$$

From equation (22), “|Vy−Vθ|=|V₂₅₅|” is established when “Cy=C₂₅₅”, i.e., steady state. Also, “|Vy−Vθ|>|V₂₅₅” is established when “Cy<C₂₅₅”, i.e., when the liquid crystal capacitance value is in such a transition state as to change from low value to high value.

For the pixel formation portion provided with a positive-polarity source high voltage Vh as the first-period pixel electrode voltage Vμ, the liquid crystal application voltage “Vy−Vθ” during the second period is expressed by the following equation based on equations (8) and (21).

$$[ Eq . 23 ]$$

$$\begin{matrix}Vy - V θ = \frac{C α ( V μ - V ω ) + Cs ( V μ - V θ + Vb - Va )}{Cy + Cs} \\ = \frac{C α ( Vh - 0 V ) + Cs ( Vh - Vh + VL - VH )}{Cy + Cs} \\ = \frac{( C α + Cs ) Vh - ( {C}_{255} + Cs ) {V}_{255}}{Cy + {Cs}^{′}}\end{matrix} \qquad ( 23 )$$

Here, the source high voltage Vh is set such that the following equation is established based on equation (23) when “Cy=Cα” and “Cα=C₀”, i.e., when the liquid crystal capacitance value is in steady state at C₀ through the first and second periods.

$$\begin{matrix}[ Eq . 24 ] & \\ \begin{matrix}Vy - V θ = \frac{( {C}_{0} + Cs ) Vh - ( {C}_{255} + Cs ) {V}_{255}}{{C}_{0} + Cs} \\ = - {V}_{0}\end{matrix} & ( 24 )\end{matrix}$$

From equation (24), the source high voltage Vh is expressed by the following equation.

$$[ Eq . 25 ]$$

$$( {C}_{0} + Cs ) Vh = - ( {C}_{0} + Cs ) {V}_{0} + ( {C}_{255} + Cs ) {V}_{255} \\ ∴ Vh = - {V}_{0} + \frac{( {C}_{255} + Cs ) {V}_{255}}{{C}_{0} + Cs} \qquad ( 25 )$$

Also, when “C₀<Cy” and “Cy<Cα”, i.e., when the liquid crystal capacitance value is in such a transition state as to change from high value to low value the liquid crystal application voltage “Vy−Vθ” during the second period is expressed by the following equation based on equations (23) and (25).

$$[ Eq . 26 ]$$

$$\begin{matrix}Vy - V θ = \frac{( C α + Cs ) Vh - ( {C}_{255} + Cs ) {V}_{255}}{Cy + Cs} \\ = \frac{\begin{matrix}( C α + Cs ) ( \frac{\begin{matrix}- {V}_{0} + \\ ( {C}_{255} + Cs ) {V}_{255}\end{matrix}}{( {C}_{0} + Cs )} ) - \\ ( {C}_{255} + Cs ) {V}_{255}\end{matrix}}{Cy + Cs} \\ = \frac{\begin{matrix}- ( C α + Cs ) ( {C}_{0} + Cs ) {V}_{0} + \\ ( C α + Cs ) ( {C}_{255} + Cs ) {V}_{255} - \\ ( {C}_{0} + Cs ) ( {C}_{255} + Cs ) {V}_{255}\end{matrix}}{( Cy + Cs ) ( {C}_{0} + Cs )} \\ = \frac{\begin{matrix}- ( C α + Cs ) ( {C}_{0} + Cs ) {V}_{0} + \\ ( C α + Cs ) ( {C}_{255} + Cs ) {V}_{255}\end{matrix}}{( Cy + Cs ) ( {C}_{0} + Cs )} \\ = \frac{\begin{matrix}- ( Cy + Cs ) ( {C}_{0} + Cs ) {V}_{0} + \\ ( Cy + C α ) ( {C}_{0} + Cs ) {V}_{0} + \\ ( C α - Cy ) ( {C}_{255} + Cs ) {V}_{255} + \\ ( Cy - {C}_{0} ) ( {C}_{255} + Cs ) {V}_{255}\end{matrix}}{( Cy + Cs ) ( {C}_{0} + Cs )} \\ = - {V}_{0} + \frac{( C α - Cy ) ( \begin{matrix}( {C}_{255} + Cs ) {V}_{255} - \\ ( C 0 + Cs ) V 0\end{matrix} )}{( {C}_{0} + Cs ) ( Cy + Cs )} + \\ \frac{( Cy - {C}_{0} ) ( {C}_{255} + Cs ) {V}_{255}}{( {C}_{0} + Cs ) ( Cy + Cs )}\end{matrix} \qquad ( 26 )$$

The right-hand side of equation (26) is the same as that of equation (18), and therefore “|Vy−Vθ|<|V₀|” is established when “Cα>Cy” and “Cy>C₀”, i.e., when the liquid crystal capacitance value is in such a transition state as to change from high value to low value.

<3.2.2 About the Second-Row Pixel Formation Portion>

Next, focus is placed on the second-row pixel formation portion A2j. For the second-row pixel formation portion A2j, the period from point t01 to point t02 corresponds to the first period. During the period from point t01 to point t02, a selection voltage is applied to the second-row gate line G2. As a result, the TFT 20 is brought into conductive state. Also, during this period, the opposing electrode voltage Com is set at the source high voltage Vh. Furthermore, during this period, the first-period pixel electrode voltage Vμ having a value calculated based on equation (11) is applied to the source line Sj. Here, during this period, unlike during the period from point t0 to point t01, when a gray-scale value which the input signal Dx indicates is “255”, the first-period pixel electrode voltage Vμ is set at V₂₅₅, and when a gray-scale value which the input signal Dx indicates is “0”, the first-period pixel electrode voltage Vμ is set at 0V. As a result, the first-period pixel electrode voltage Vμ in the range from 0V to V₂₅₅ is applied to the pixel electrode 21 of the pixel formation portion A2j in accordance with the magnitude of the target voltage Vβ. Note that during this period, the auxiliary capacitance line low voltage VL is applied to the second-row auxiliary capacitance line C1.

During the period from point t02 to point t11, a non-selection voltage is applied to the second-row gate line G2. As a result, the TFT 20 is brought into non-conductive state. Also, at point t02, the opposing electrode voltage Com is caused to change from the source high voltage Vh to 0V, and the voltage applied to the first-row auxiliary capacitance line C1 is caused to change from the auxiliary capacitance line low voltage VL to the auxiliary capacitance line high voltage VH. As a result, the pixel electrode voltage of the pixel formation portion A1j is set in the range from “V₂₅₅ to 0V”.

By performing the above-described drive, for the pixel formation portion provided with the source high voltage Vh as the first-period pixel electrode voltage Vμ, the liquid crystal application voltage “Vy−Vθ” during the second period is expressed by the following equation based on equations (8) and (21).

$$[ Eq . 27 ]$$

$$\begin{matrix}Vy - V θ = \frac{C α ( V μ - V ω ) + Cs ( V μ - V θ + Vb - Va )}{Cy + Cs} \\ = \frac{C α ( Vh - Vh ) + Cs ( Vh - 0 V + VH - VL )}{Cy + Cs} \\ = \frac{( {C}_{255} + Cs ) {V}_{255}}{Cy + Cs}\end{matrix} \qquad ( 27 )$$

From equation (27), “|VY−Vθ|=|V₂₅₅|” is established when “Cy=C₂₅₅”, i.e., steady state. Also, “|Vy−Vθ|>|V₂₅₅|” is established when “Cy<C₂₅₅”, i.e., transition state.

For the pixel formation portion provided with a voltage of 0V as the first-period pixel electrode voltage Vμ, the liquid crystal application voltage “Vy−Vθ” during the second period is expressed by the following equation based on equations (8) and (21).

$$\begin{matrix}[ Eq . 28 ] & \\ \begin{matrix}Vy - V θ = \frac{C α ( V μ - V ω ) + Cs ( V μ - V θ + Vb - Va )}{Cy + Cs} \\ = \frac{C α ( 0 V - Vh ) + Cs ( 0 V - 0 V + VH - VL )}{Cy + Cs} \\ = \frac{( C α + Cs ) ( - Vh ) + Cs ( Vh + VH - VL )}{Cy + Cs} \\ = \frac{( C α + Cs ) ( - Vh ) + ( {C}_{255} + Cs ) {V}_{255}}{Cy + Cs}\end{matrix} & ( 28 )\end{matrix}$$

Based on equation (25), equation (28) is transformed as follows.

$$[ Eq . 29 ]$$

$$\begin{matrix}Vy - V θ = \frac{( C α + Cs ) ( - Vh ) + ( {C}_{255} + Cs ) {V}_{255}}{Cy + Cs} \\ = \frac{\begin{matrix}( C α + Cs ) ( \frac{\begin{matrix}{V}_{0} - \\ ( {C}_{255} + Cs ) {V}_{255}\end{matrix}}{( {C}_{0} + Cs )} ) + \\ ( {C}_{255} + Cs ) {V}_{255}\end{matrix}}{Cy + Cs} \\ = \frac{\begin{matrix}( C α + Cs ) ( {C}_{0} + Cs ) {V}_{0} - \\ ( C α + Cs ) ( {C}_{255} + Cs ) {V}_{255} + \\ ( {C}_{0} + Cs ) ( {C}_{255} + Cs ) {V}_{255}\end{matrix}}{( Cy + Cs ) ( {C}_{0} + Cs )} \\ = \frac{\begin{matrix}( C α + Cs ) ( {C}_{0} + Cs ) {V}_{0} - \\ ( C α + {C}_{0} ) ( {C}_{255} + Cs ) {V}_{255} )\end{matrix}}{( Cy + Cs ) ( {C}_{0} + Cs )} \\ = \frac{\begin{matrix}( Cy + Cs ) ( {C}_{0} + Cs ) {V}_{0} - \\ ( Cy - C α ) ( {C}_{0} + Cs ) {V}_{0} - \\ ( C α - Cy ) ( {C}_{255} + Cs ) {V}_{255} ) - \\ ( Cy - {C}_{0} ) ( {C}_{255} + Cs ) {V}_{255}\end{matrix}}{( Cy + Cs ) ( {C}_{0} + Cs )} \\ = {V}_{0} - \frac{( C α - Cy ) ( \begin{matrix}( {C}_{255} + Cs ) {V}_{255} - \\ ( {C}_{0} + Cs ) {V}_{0}\end{matrix} )}{( {C}_{0} + Cs ) ( Cy + Cs )} - \\ \frac{( Cy - {C}_{0} ) ( {C}_{255} + Cs ) {V}_{255}}{( {C}_{0} + Cs ) ( Cy + Cs )}\end{matrix} \qquad ( 29 )$$

The right-hand side of equation (29) is the same as that of equation (20), and therefore “|Vy−Vθ|=|V₀|” is established when “Cy=Cα” and “Cα=C₀”, i.e., when the liquid crystal capacitance value is in steady state at C₀ through the first and second periods. Also, “|Vy−Vθ|<|V₀|” is established when “Cα>Cy” and “Cy>C₀”, i.e., when the liquid crystal capacitance value is in such a transition state as to change from high value to low value.

### 3.3 Effect

As described above, according to the present embodiment, “|Vy−Vθ|>|V₂₅₅|” is established when the liquid crystal capacitance value is in such a transition state as to change from low value to high value. That is, a voltage above the target voltage is applied to the liquid crystal during the transition period. Also, “|Vy−Vθ|<|V₀|” is established when the liquid crystal capacitance value is in such a transition state as to change from high value to low value. That is, a voltage below the target voltage is applied to the liquid crystal during the transition period. Also, as in the first embodiment, no frame memory is provided for retaining information indicating the immediately previous state of display.

Thus, the (liquid crystal) response speed of the liquid crystal display device configured such that high- and low-potential voltages are alternatingly provided to the opposing electrode 24 is improved without incorporating frame memory.

### 3.4 Variant

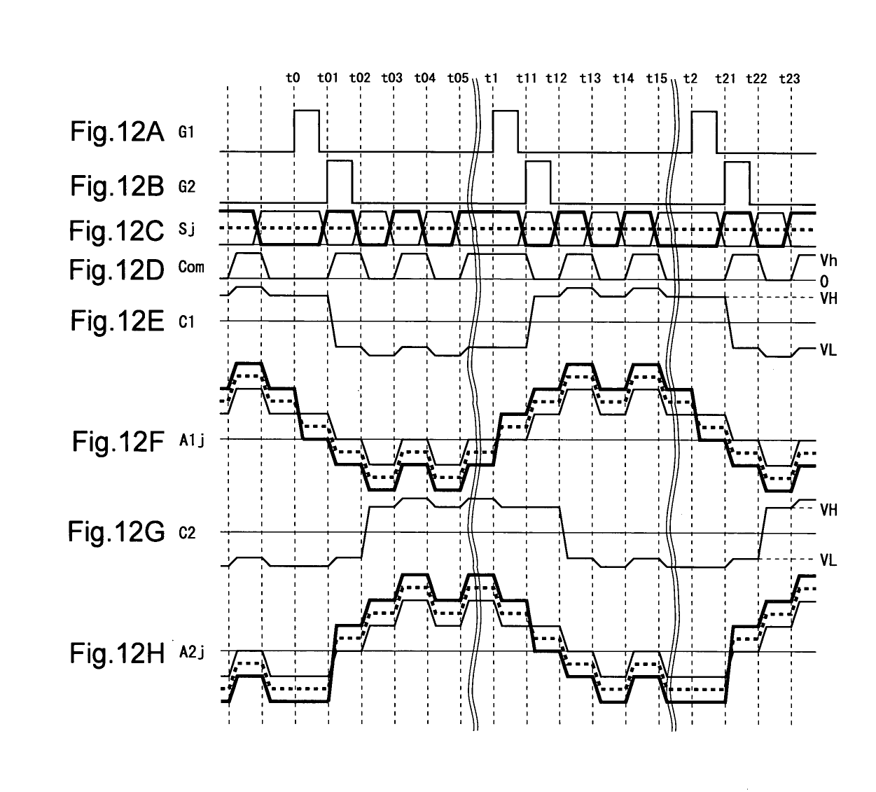

In the second embodiment, after the voltage on the auxiliary capacitance line Ck changes at the start point of the second period, through the period up to the end point of the second period, the voltage on the auxiliary capacitance line CK is maintained. Here, a voltage of 0V and the source high voltage Vh are alternatingly provided to the opposing electrode 24 every horizontal scanning period. Accordingly, the liquid crystal application voltage also changes in accordance with the change of the opposing electrode voltage. Therefore, the voltage provided to the auxiliary capacitance line is preferably caused to change in accordance with the change of the opposing electrode voltage, as shown in FIG. 12. With this configuration, the amount of charge redistributed between the auxiliary capacitance and the element capacitance decreases, and therefore a stable voltage is applied to the liquid crystal.

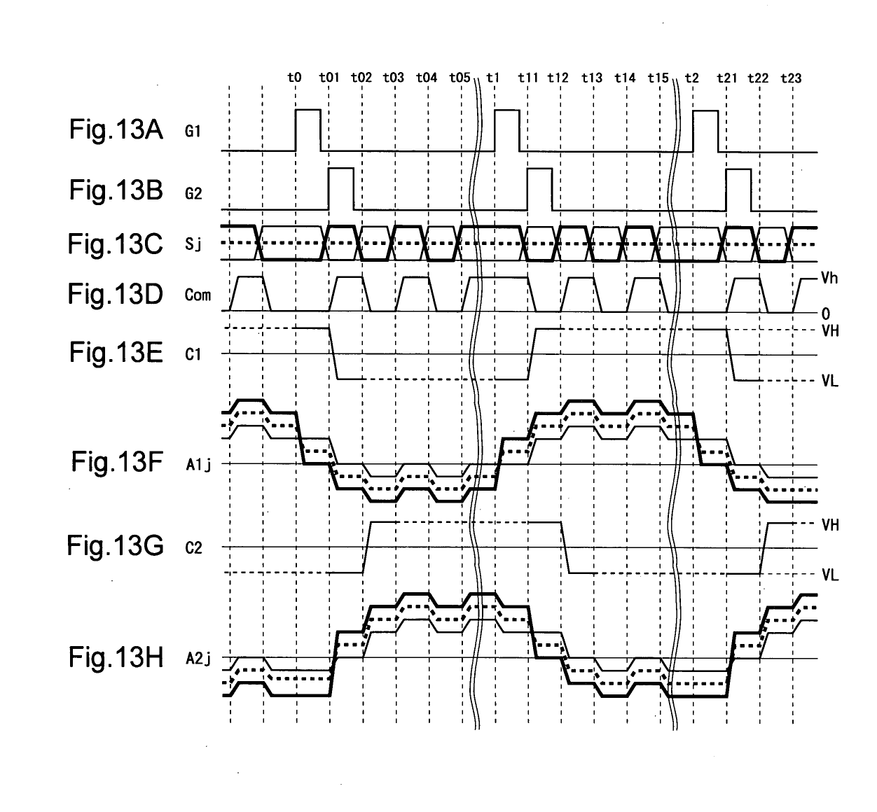

Also, the auxiliary capacitance line Ck and the auxiliary capacitance driver 500 may be electrically disconnected during the second period, such that the charge accumulated on the auxiliary capacitance line Ck is retained (see FIG. 13). As a result, the pixel electrode voltage changes in accordance with the change of the opposing electrode voltage because the pixel electrode 21 and the opposing electrode 24 are capacitively coupled. Also, the voltage on the auxiliary capacitance line Ck changes in accordance with the change of the pixel electrode voltage because the pixel electrode 21 and the auxiliary capacitance line Ck are capacitively coupled. As a result, a stable voltage is applied to the liquid crystal.

### 4. Third Embodiment

### 4.1 Configuration

In a liquid crystal display device according to the present embodiment, general configurations of the drivers and the display portion 200 are the same as in the second embodiment shown in FIG. 10. However, there are differences from the second embodiment in terms of the magnitude of a voltage provided to the auxiliary capacitance lines C1 to Cm from the auxiliary capacitance driver 500 and the magnitude of a voltage provided to the opposing electrode 24 from the opposing electrode driver 600. Specifically, while in the second embodiment, the first-period opposing electrode voltage V_{ω} is set to be equal in magnitude to the source voltage having a gray-scale value of “255” (a voltage of 0V or the source high voltage Vh), in the present embodiment, the first-period opposing electrode voltage Vω is set to be “−Vd” on the low-potential side and “Vh+Vd” on the high-potential side. In this manner, in the present embodiment, the amplitude of the opposing electrode voltage is set higher than in the second embodiment.

### 4.2 Drive Method

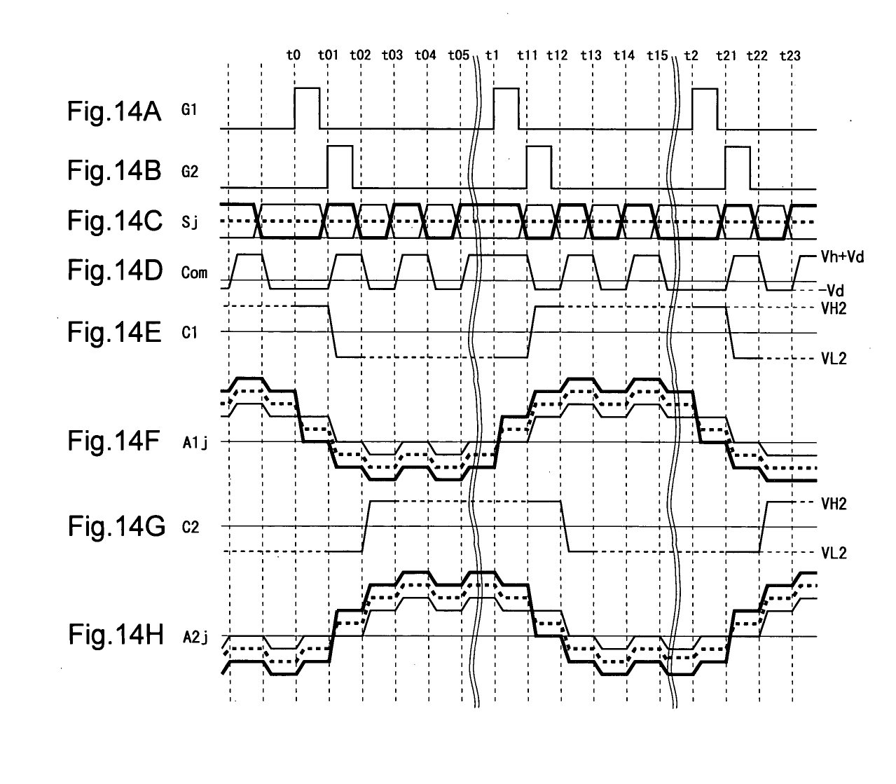

FIG. 14 is a signal waveform diagram describing the drive method of the present embodiment. The meanings of lines in FIGS. 14C, 14F, and 14H are the same as those of the lines in FIGS. 1C, 1F, and 1H for the first embodiment. Note that in the present embodiment also, descriptions will be provided on the assumption that the target voltage Vβ for the first-row pixel formation portion A1j has the negative polarity during the frame period from point t0 to point t1.

During the period from point t0 to point t01, a selection voltage is applied to the first-row gate line G1. As a result, the TFT 20 included in the first-row pixel formation portion A1j is brought into conductive state. Also, during this period, the opposing electrode voltage Com is set as a predetermined negative-polarity voltage “−Vd”. Furthermore, during this period, the first-period pixel electrode voltage Vμ having a value calculated based on equation (11) is applied to the source line Sj. In the present embodiment, as in the second embodiment, during this period, when a gray-scale value which the input signal Dx indicates is “0”, the first-period pixel electrode voltage Vμ is set at V₂₅₅, and when a gray-scale value which the input signal Dx indicates is “255”, the first-period pixel electrode voltage Vμ is set at 0V. As a result, the first-period pixel electrode voltage Vμ in the range from 0V to V₂₅₅ is applied to the pixel electrode 21 of the pixel formation portion A1j in accordance with the magnitude of the target voltage Vβ. Note that during this period, a predetermined high-potential voltage VH2 is applied to the first-row auxiliary capacitance line C1.

During the period from point t01 to point t1, a non-selection voltage is applied to the first-row gate line G1. As a result, the TFT 20 included in the first-row pixel formation portion A1j is brought into non-conductive state. Also, at point t01, the opposing electrode voltage Com is caused to change from the voltage “−Vd” to a predetermined positive-polarity voltage “Vh+Vd”, and the voltage applied to the first-row auxiliary capacitance line C1 is caused to change from the voltage VH2 to a predetermined low-potential voltage VL2. As a result, the pixel electrode voltage of the pixel formation portion A1j is set in the range from “−V₂₅₅ to 0V”.

Incidentally, in the present embodiment, the voltage VH2 and the voltage VL2 are preset such that a voltage of “−V₂₅₅” is applied to the liquid crystal when the liquid crystal capacitance value is in steady state at C₂₅₅ through the first and second periods and “the first-period pixel electrode voltage Vμ is “0V””, “the first-period opposing electrode voltage Vω is “−Vd””, and “the second-period opposing electrode voltage Vθ is “Vh+Vd””. Specifically, the voltages VH2 and VL2 are set such that the following equation is established based on equation (9).

$$[ Eq . 30 ]$$

$$\begin{matrix}- {V}_{255} = Vy - V θ \\ = \frac{C α ( V μ - V ω ) + Cs ( V μ - V θ + Vb - Va )}{Cy + Cs} \\ = \frac{\begin{matrix}{C}_{255} ( 0 V - ( - Vd ) ) + \\ Cs ( 0 V - ( Vh + Vd ) + VL 2 - VH 2 )\end{matrix}}{{C}_{255} + Cs} \\ = \frac{( {C}_{255} - Cs ) Vd + Cs ( - Vh + VL 2 - VH 2 )}{{C}_{255} + Cs}\end{matrix} \\ ∴ VH 2 - VL 2 + Vh = \frac{( {C}_{255} + Cs ) {V}_{255} + ( {C}_{255} - Cs ) Vd}{Cs} \qquad ( 30 )$$

Note that when the settings of the voltages VH2 and VL2 are limited in some way, the auxiliary capacitance value Cs and the voltage Vd may be set such that equation (30) is established.

By performing the above-described drive, for the pixel formation portion provided with a voltage of 0V as the first-period pixel electrode voltage Vμ, the liquid crystal application voltage “Vy−Vθ” during the second period is expressed by the following equation based on equations (8) and (30).

$$[ Eq . 31 ]$$

$$\begin{matrix}Vy - V θ = \frac{C α ( V μ - V ω ) + Cs ( V μ - V θ + Vb - Va )}{Cy + Cs} \\ = \frac{C α ( 0 V - ( - Vd ) ) + Cs ( 0 - ( Vh - Vd ) + VL 2 - VH 2 )}{Cy + Cs} \\ = \frac{( C α - Cs ) Vd + Cs ( - Vh + VL 2 - VH 2 )}{Cy + Cs} \\ = \frac{( C α - Cs ) Vd - ( \begin{matrix}( {C}_{255} + Cs ) {V}_{255} + \\ ( {C}_{255} - Cs ) Vd\end{matrix} )}{Cy + Cs} \\ = \frac{( C α - {C}_{255} ) Vd}{Cy + Cs} - \frac{( {C}_{255} + Cs ) {V}_{255}}{Cy + Cs}\end{matrix} \qquad ( 31 )$$

From equation (31), “|Vy−Vθ|=|V₂₅₅|” is established when “Cα=Cy” and “Cy=C₂₅₅”, i.e., when the liquid crystal capacitance value is in steady state at C₂₅₅ through the first and second periods. Also, “|Vy−Vθ|>|V₂₅₅|” is established when “Cα<Cy” and “Cy<C₂₅₅”, i.e., when the liquid crystal capacitance value is in such a transition state as to change from low value to high value.

For the pixel formation portion provided with the source high voltage Vh as the first-period pixel electrode voltage Vμ, the liquid crystal application voltage “Vy−Vθ” during the second period is expressed by the following equation based on equations (8) and (30).

$$[ Eq . 32 ]$$

$$\begin{matrix}Vy - V θ = \frac{C α ( V μ - V ω ) + Cs ( V μ - V θ + Vb - Va )}{Cy + Cs} \\ = \frac{\begin{matrix}C α ( Vh - ( Vh + Vd ) ) + \\ Cs ( Vh - ( - Vd ) + VH 2 - VL 2 )\end{matrix}}{Cy + Cs} \\ = \frac{- ( C α + Cs ) Vd + Cs ( Vh + VH 2 - VL 2 )}{Cy + Cs} \\ = \frac{- ( C α - Cs ) Vd + ( \begin{matrix}( {C}_{255} + Cs ) {V}_{255} + \\ ( {C}_{255} - Cs ) Vd\end{matrix} )}{Cy + Cs} \\ = \frac{( {C}_{255} - C α ) Vd}{Cy + Cs} + \frac{( {C}_{255} + Cs ) {V}_{255}}{Cy + Cs}\end{matrix} \qquad ( 32 )$$

From equation (32), “|Vy−Vθ|=|V₂₅₅” is established when “Cα=Cy” and “Cy=C₂₅₅”, i.e., when the liquid crystal capacitance value is in steady state at C₂₅₅ through the first and second periods. Also, “|Vy−Vθ|>|V₂₅₅|” is established when “Cα<Cy” and “Cy<C₂₅₅” i.e., when the liquid crystal capacitance value is in such a transition state as to change from low value to high value.

### 4.3 Effect

According to the present embodiment, as in the second embodiment, a voltage above the target voltage is applied to the liquid crystal during the transition period when the liquid crystal capacitance value is in such a transition state as to change from low value to high value, and a voltage below the target voltage is applied to the liquid crystal during the transition period when the liquid crystal capacitance value is in such a transition state as to change from high value to low value.

Here, comparing equations (31) and (22), it can be appreciated that “|Vy−Vθ|” in equation (32) is higher than “|Vy−Vθ|” in equation (27) when “Cα<Cy” and “Cy<C₂₅₅” because the first term on the right-hand side (in the last row) of equation (31) is negative. Also, comparing equations (32) and (27), it can be appreciated that “|Vy−Vθ|” in equation (31) is higher than “|Vy−Vθ|” in equation (22) when “Cα<Cy” and “Cy<C₂₅₅” because the first term on the right-hand side (in the last row) of equation (32) is positive. Furthermore, it can be appreciated that the value of “|VY−Vθ|” in equations (31) and (32) fluctuates in accordance with the value of Vd. Thus, according to the present embodiment, by appropriately setting the value of Vd, it becomes possible to realize a liquid crystal display device capable of better achieving the overshoot effect.

### 5. Fourth Embodiment

### 5.1 Configuration

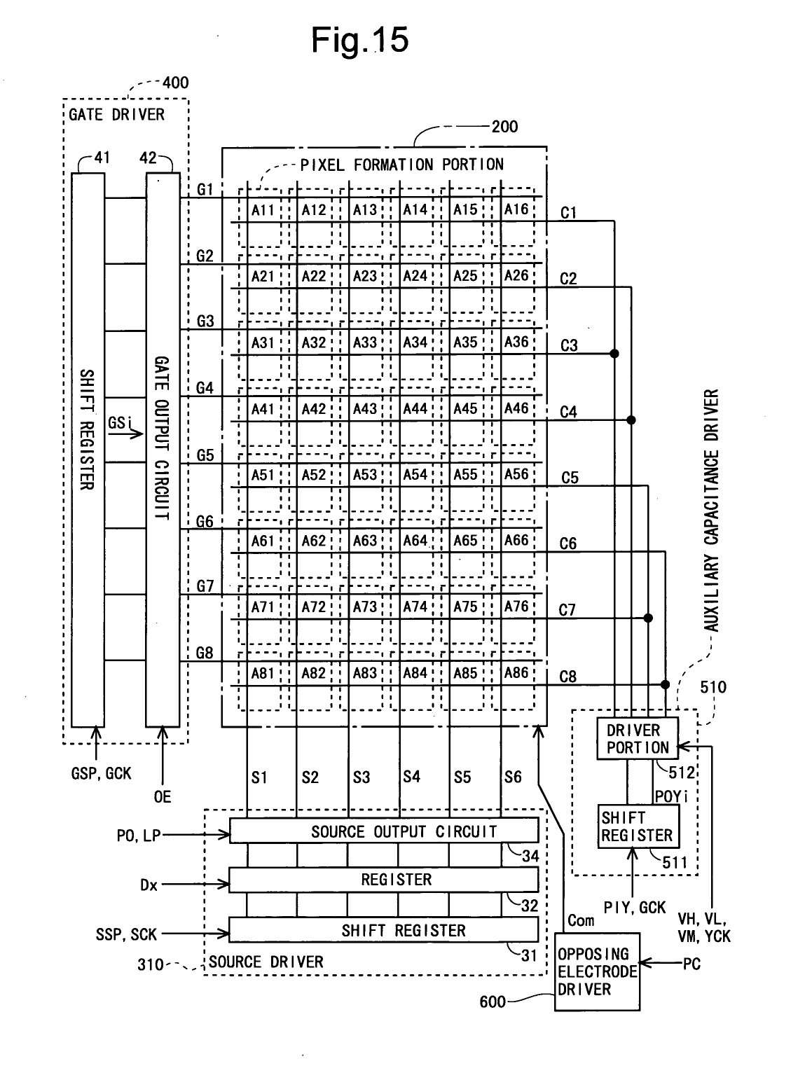

FIG. 15 is a block diagram illustrating detailed configurations of the drivers and the display portion 200 in a liquid crystal display device according to a fourth embodiment of the present invention. In the present embodiment, the auxiliary capacitance driver is configured differently from that in the second embodiment. Also, the first-row auxiliary capacitance line C1 is short-circuited with the third-row auxiliary capacitance line C3, the second-row auxiliary capacitance line C2 is short-circuited with the fourth-row auxiliary capacitance line C4, the fifth-row auxiliary capacitance line C5 is short-circuited with the seventh-row auxiliary capacitance line C7, and the sixth-row auxiliary capacitance line C6 is short-circuited with the eighth-row auxiliary capacitance line C8. Other features, i.e., the source driver 310, the gate driver 400, and the opposing electrode driver 600, are configured in the same manner as in the second embodiment, and therefore any descriptions thereof will be omitted.

An auxiliary capacitance driver 510 includes a shift register 511 and a driver portion 512. A selection signal PIY and a gate clock signal GCK are inputted into the shift register 511. The selection signal PIY inputted to the shift register 511 is sequentially transferred through the shift register 511 based on the gate clock signal GCK. In response to the transfer of the selection signal PIY, a polarity signal POYi is outputted from the shift register 51, and the polarity signal POYi is inputted into the driver portion 512.

Based on a predetermined clock signal YCK provided by the display control circuit 100 and the polarity signal POYi outputted from the shift register 511, the driver portion 512 outputs a predetermined positive-polarity voltage VH, a predetermined negative-polarity voltage VL or a medium voltage VM to the auxiliary capacitance line as an auxiliary capacitance drive signal. Note that the predetermined clock signal YCK places an interval of one horizontal scanning period, for example, between the timing of changing the voltage provided to the first- and third-row auxiliary capacitance lines C1 and C3 and the timing of changing the voltage provided to the second- and fourth-row auxiliary capacitance lines C2 and C4.

### 5.2 Drive Method

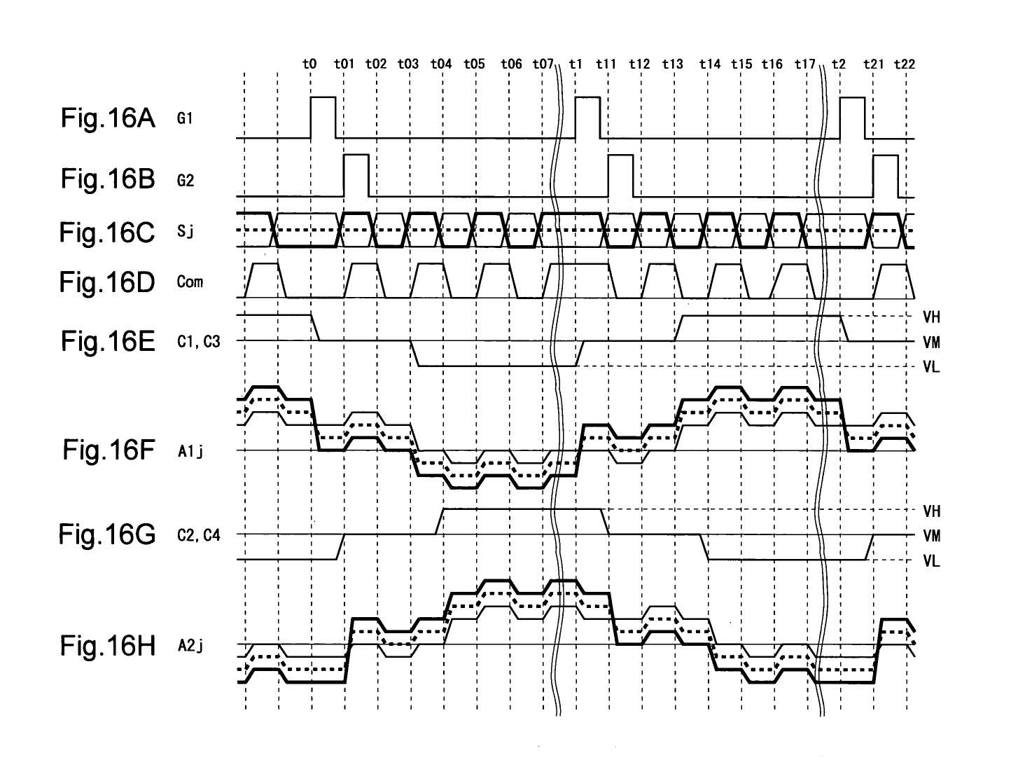

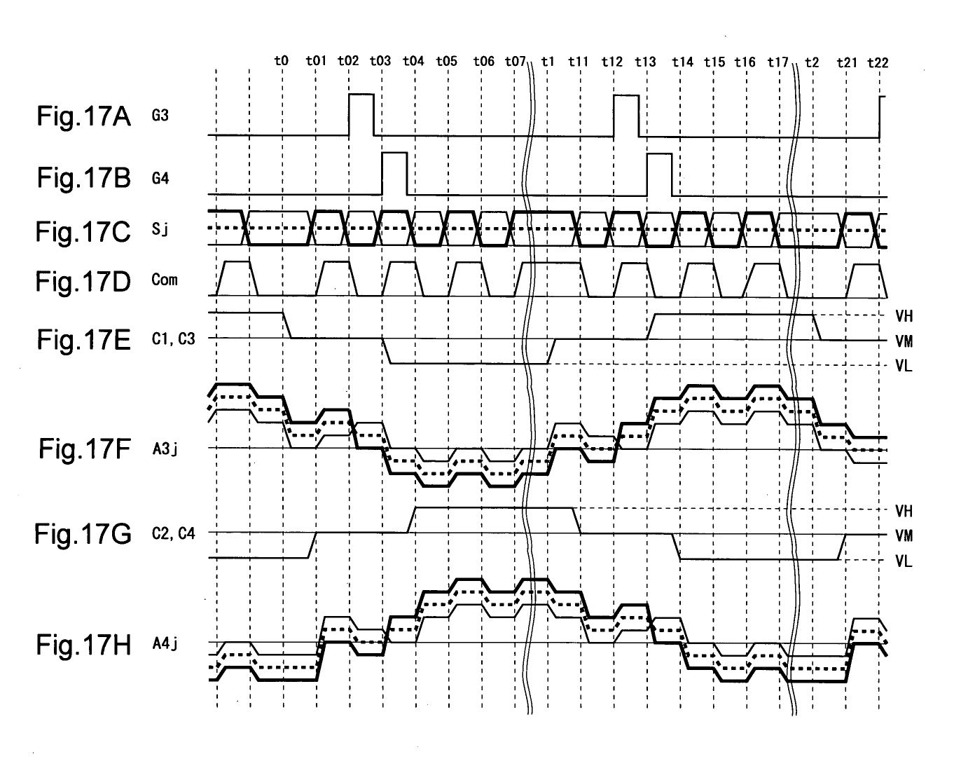

FIGS. 16 and 17 are signal waveform diagrams describing the drive method of the present embodiment. The meanings of lines in FIGS. 16C, 16F, and 16H are the same as those of the lines in FIGS. 1C, 1F, and 1H for the first embodiment. The same applies to FIGS. 17C, 17F, and 17H. Note that in the present embodiment also, descriptions will be provided on the assumption that the target voltage Vβ for the first-row pixel formation portion A1j has the negative polarity during the frame period from point t0 to point t1.

As described above, in the present embodiment, for example, the first-row auxiliary capacitance line C1 is short-circuited with the third-row auxiliary capacitance line C3. Accordingly, the first-row pixel formation portion A1j and the third-row pixel formation portion A3j are equal in terms of the start and endpoints of the first and second periods. Hereinafter, the drive method of the present embodiment will be described focusing on the first- and third-row pixel formation portions A1j and A3j.

During the period from point t0 to point t01, a selection voltage is applied to the first-row gate line G1. As a result, the TFT 20 included in the first-row pixel formation portion A1j is brought into conductive state. For the third-row gate line G3, a non-selection voltage is kept applied, and therefore the TFT 20 included in the third-row pixel formation portion A3j is maintained in non-conductive state. Also, during this period, the opposing electrode voltage Com is set at 0V, and the medium voltage VM is applied to the first- and third-row auxiliary capacitance lines C1 and C3. Furthermore, during this period, for the first-row pixel, formation portion A1j, the first-period pixel electrode voltage V_{μ} having a value calculated based on equation (11) is applied to the source line Sj. In the present embodiment, while a voltage in the range from 0V to V₂₅₅ is applied to the source line Sj as the first-period pixel electrode voltage Vμ, during this period, when a gray-scale value which the input signal Dx indicates is “0”, the first-period pixel electrode voltage Vμ is set at V₂₅₅, and when a gray-scale value which the input signal Dx indicates is “255”, the first-period pixel electrode voltage Vμ is set at 0V. As a result, the first-period pixel electrode voltage Vμ in the range from 0V to V₂₅₅ is applied to the pixel electrode 21 of the first-row pixel formation portion A1j in accordance with the magnitude of the target voltage Vβ. A voltage after fluctuations resulting from changes of the opposing electrode voltage Com and the voltage on the third-row auxiliary capacitance line C3 is applied to the pixel electrode 21 of the third-row pixel formation portion A3j based on the voltage applied during the first period of the previous frame.

During the period from point t01 to point t02, a non-selection voltage is applied to the first-row gate line G1. As a result, the TFT 20 included in the first-row pixel formation portion A1j is brought into non-conductive state. For the third-row gate line G3, the non-selection voltage is kept applied, and therefore the TFT 20 included in the third-row pixel formation portion A3j is maintained in non-conductive state. Also, during this period, the opposing electrode voltage Com is caused to change from 0V to the source high voltage Vh, and the voltage on the first- and third-row auxiliary capacitance lines C1 and C3 are maintained at the medium voltage VM. Thus, the potentials of the pixel electrodes 21 in the first- and third-row pixel formation portions A1j and A3j rise in accordance with the change of the opposing electrode voltage Com, as shown in FIGS. 16F and 17F.

During the period from point t02 to point t03, a selection voltage is applied to the third-row gate line G3. As a result, the TFT 20 included in the third-row pixel formation portion A3j is brought into conductive state. For the first-row gate line G1, a non-selection voltage is kept applied, and therefore the TFT 20 included in the first-row pixel formation portion A1j is maintained in non-conductive state. Also, during this period, the opposing electrode voltage Com is caused to change from the source high voltage Vh to 0V, and the voltage on the first- and third-row auxiliary capacitance lines C1 and C3 is maintained at the medium voltage VM. Furthermore, for the third-row pixel formation portion A3j, during this period, the first-period pixel electrode voltage Vμ having a value calculated based on equation (11) is applied to the source line Sj. As a result, the first-period pixel electrode voltage Vμ in the range from 0V to V₂₅₅ is applied to the pixel electrode 21 of the third-row pixel formation portion A3j in accordance with the magnitude of the target voltage Vβ. Also, the potential of the pixel electrode 21 in the first-row pixel formation portion A1j falls in accordance with the change of the opposing electrode voltage Com.

During the period from point t03 to point t04, a non-selection voltage is applied to the third-row gate line G3. As a result, the TFT 20 included in the third-row pixel formation portion A3j is brought into non-conductive state. For the first-row gate line G1, the non-selection voltage is kept applied, and therefore the TFT 20 included in the first-row pixel formation portion A1j is maintained in non-conductive state. Also, during this period, while the opposing electrode voltage Com is caused to change from 0V to the source high voltage Vh, the voltage on the first- and third-row auxiliary capacitance lines C1 and C3 is caused to change from the medium voltage VM to the negative-polarity voltage VL. As a result, the potentials of the pixel electrodes 21 in the first- and third-row pixel formation portions A1j and A3j fall as shown in FIGS. 16F and 17F.

During the period from point t04 to point t1, a non-selection voltage is kept applied to the first- and third-row gate lines G1 and G3. Also, during this period, while the voltage on the first- and third-row auxiliary capacitance lines C1 and C3 is maintained at the negative-polarity voltage VL, the opposing electrode voltage Com is caused to alternatingly change between 0V and the source high voltage Vh every horizontal scanning period. As a result, the potentials of the pixel electrodes 21 in the first- and third-row pixel formation portions A1j and A3j repeatedly rise and fall in accordance with the change of the opposing electrode voltage Com, as shown in FIGS. 16F and 17F.

Incidentally, in the present embodiment, the negative-polarity voltage VL and the medium voltage VM are preset such that a voltage of “V₂₅₅” is applied to the liquid crystal during the second period when the liquid crystal capacitance value is in steady state at C₂₅₅ and “the first-period pixel electrode voltage Vμ is 0V”, “the first-period opposing electrode voltage Vω is 0V” and “the second-period opposing electrode voltage Vθ is the source high voltage Vh”. Specifically, by making substitutions in equation (9) such that “Va=VM” and “Vb=VL”, the negative-polarity voltage VL and the medium voltage VM may be obtained as in the second embodiment. Note that the positive-polarity voltage VH can be obtained based on the negative-polarity voltage VL and the medium voltage VM.

### 5.3 Effect

According to the present embodiment, during the second period, a desired voltage is applied to the liquid crystal in each pixel formation portion in accordance with the target voltage Vβ. At this time, if the liquid crystal capacitance value is in such a transition state as to change from low value to high value, a voltage above the target voltage Vβ is applied to the liquid crystal during the transition period, and if the liquid crystal capacitance value is in such a transition state as to change from high value to low value, a voltage below the target voltage Vβ is applied to the liquid crystal during the transition period.

Here, in the present embodiment, the auxiliary capacitance lines Ck are paired and short-circuited with each other. Thus, the circuit scale of the auxiliary capacitance driver 510 is reduced when compared to the first through third embodiments.

Incidentally, the second period for each pixel formation portion becomes shorter as the number of auxiliary capacitance lines Ck to be short-circuited with one other increases. However, even in the case of, for example, a liquid crystal display device with 320 gate lines, in which the auxiliary capacitance lines Ck are short-circuited eight by eight, the length of the second period is ensured to be 90% or more of the second period for the configuration in which no auxiliary capacitance lines Ck are short-circuited. That is, by short-circuiting the auxiliary capacitance lines Ck in groups of an appropriate number, it becomes possible to reduce the circuit scale of the auxiliary capacitance driver 510 without reducing display quality.

### 6. Others

While each of the above embodiments has been described on the premise of a liquid crystal display device capable of an 8 gray-scale gradation display, the present invention is not limited to this. The present invention is also applicable to cases where the number of gray-scale levels is other than eight. Also, while each embodiment has been described taking the liquid crystal display device as an example, the present invention is applicable to other display devices as well, in addition to the liquid crystal display device, so long as electro-optic elements are employed as display elements in which element capacitance values change in accordance with a change of an application voltage.

1. A display device comprising:
a plurality of video signal lines;
a plurality of scanning signal lines crossing the video signal lines;
a plurality of auxiliary capacitance lines provided in one-to-one correspondence with the scanning signal lines;
a plurality of pixel formation portions arranged in a matrix at their respective intersections of the video signal lines and the scanning signal lines, the pixel formation portions each including an element capacitance for accumulating a charge corresponding to a luminance of an image to be displayed and an auxiliary capacitance provided in parallel with the element capacitance; and
a driver circuit for controlling voltages to be applied to the video signal lines, the scanning signal lines, and the auxiliary capacitance lines, thereby controlling voltages to be applied to the element capacitances and the auxiliary capacitances, wherein,
each pixel formation portion includes a switching element controlled in terms of conductive/non-conductive state by a scanning signal provided through a corresponding scanning signal line, a pixel electrode electrically connected to a corresponding video signal line via the switching element, a common electrode for forming the element capacitance between the pixel electrode and the common electrode, and the auxiliary capacitance line for forming the auxiliary capacitance between the pixel electrode and the auxiliary capacitance line,
for any given pixel formation portion, a frame period which is a period in which a display for one screen is provided consists of a first period and a second period which is a period other than the first period, and
for each pixel formation portion, during the frame period in which a target voltage is to be applied to the pixel electrode, the target voltage corresponding to the luminance of the image to be displayed and having one of the positive and negative polarities with respect to a potential of the common electrode, during the first period, the driver circuit brings the switching element into conductive state by applying a predetermined selection voltage to the corresponding scanning signal line and applies a voltage to the corresponding video signal line based on the target voltage, thereby applying to the pixel electrode a voltage of the other polarity with respect to the potential of the common electrode, while during the second period, the driver circuit brings the switching element into non-conductive state by applying a predetermined non-selection voltage to the corresponding scanning signal line and changes a voltage applied to a corresponding auxiliary capacitance line from the other polarity to one polarity with respect to the potential of the common electrode.

2. The display device according to claim 1, wherein,
the driver circuit further applies a voltage to the common electrode, the voltage alternating between the positive and negative polarities with respect to a predetermined potential every predetermined period, and
for each pixel formation portion, upon transition from the first period to the second period, the driver circuit changes the voltage applied to the common electrode from one polarity to the other polarity with respect to the predetermined potential.

3. The display device according to claim 2, wherein for each pixel formation portion, after the driver circuit changes the voltage applied to the common electrode upon transition from the first period to the second period, during the second period, the driver circuit lowers the potential of the corresponding auxiliary capacitance line when the voltage applied to the common electrode is caused to change from the positive polarity to the negative polarity, and raises the potential of the corresponding auxiliary capacitance line when the voltage applied to the common electrode is caused to change from the negative polarity to the positive polarity.

4. The display device according to claim 2, wherein for each pixel formation portion, after the driver circuit changes the voltage applied to the common electrode upon transition from the first period to the second period, the driver circuit brings the corresponding auxiliary capacitance line into an electrically floating state during the second period.

5. The display device according to claim 1, wherein the driver circuit drives the auxiliary capacitance lines independently of one another.

6. The display device according to claim 1, wherein,
the auxiliary capacitance lines are divided into a plurality of groups by short-circuiting a plurality of lines with each other, and
the driver circuit drives the auxiliary capacitance lines group by group.

7. A drive method for a display device, wherein,
the display device includes:
a plurality of video signal lines;
a plurality of scanning signal lines crossing the video signal lines;
a plurality of auxiliary capacitance lines provided in one-to-one correspondence with the scanning signal lines; and
a plurality of pixel formation portions arranged in a matrix at their respective intersections of the video signal lines and the scanning signal lines, the pixel formation portions each including an element capacitance for accumulating a charge corresponding to a luminance of an image to be displayed and an auxiliary capacitance provided in parallel with the element capacitance,
each pixel formation portion includes a switching element controlled in terms of conductive/non-conductive state by a scanning signal provided through a corresponding scanning signal line, a pixel electrode electrically connected to a corresponding video signal line via the switching element, a common electrode for forming the element capacitance between the pixel electrode and the common electrode, and the auxiliary capacitance line for forming the auxiliary capacitance between the pixel electrode and the auxiliary capacitance line,
for any given pixel formation portion, a frame period which is a period in which a display for one screen is provided consists of a first period and a second period which is a period other than the first period, and
the method comprises first and second drive steps for each pixel formation portion:
the first drive step being such that, during the frame period in which a target voltage is to be applied to the pixel electrode, the target voltage corresponding to the luminance of the image to be displayed and having one of the positive and negative polarities with respect to a potential of the common electrode, during the first period, the switching element is brought into conductive state by applying a predetermined selection voltage to the corresponding scanning signal line and a voltage is applied to the corresponding video signal line based on the target voltage, thereby applying to the pixel electrode a voltage of the other polarity with respect to the potential of the common electrode; and
the second drive step being such that, during the frame period in which the target voltage is to be applied to the pixel electrode, during the second period, the switching element is brought into non-conductive state by applying a predetermined non-selection voltage to the corresponding scanning signal line and a voltage applied to a corresponding auxiliary capacitance line is changed from the other polarity to one polarity with respect to the potential of the common electrode.

8. The drive method according to claim 7, further comprising a common electrode drive step of applying a voltage to the common electrode, the voltage alternating between the positive and negative polarities with respect to a predetermined potential every predetermined period, wherein,
in the common electrode drive step, for each pixel formation portion, upon transition from the first period to the second period, the voltage applied to the common electrode is caused to change from one polarity to the other polarity.

9. The drive method according to claim 8, wherein, in the second drive step, for each pixel formation portion, after changing the voltage applied to the common electrode upon transition from the first period to the second period, during the second period, the potential of the corresponding auxiliary capacitance line is lowered when the voltage applied to the common electrode changes from the positive polarity to the negative polarity, and the potential of the corresponding auxiliary capacitance line is raised when the voltage applied to the common electrode changes from the negative polarity to the positive polarity.

10. The drive method according to claim 8, wherein, in the second drive step, for each pixel formation portion, after changing the voltage applied to the common electrode upon transition from the first period to the second period, the corresponding auxiliary capacitance line is brought into an electrically floating state during the second period.

11. The drive method according to claim 7, wherein, in the first and second drive steps, the auxiliary capacitance lines are driven independently of one another.

12. The drive method according to claim 7, wherein,
the auxiliary capacitance lines are divided into a plurality of groups by short-circuiting a plurality of lines with each other, and
in the first and second drive steps, the auxiliary capacitance lines are driven group by group.
